(19) United States
(12) Patent Application Publication
(10) Pub. No.: US 2012/0219935 A1
(43) Pub. Date: Aug. 30, 2012

(54) METHODS, SYSTEMS, AND DEVICES FOR INTERACTIVE LEARNING

(76) Inventors: Kim Stebbings, Tampa, FL (US); Ofer Yodfat, Modi'in (IL); Gary Scheiner, Cynwyd, PA (US)

(21) Appl. No.: 13/388,378

(22) PCT Filed: Aug. 1, 2010
(86) PCT No.: PCT/IL2010/000617

§ 371 Date: May 15, 2012

Related U.S. Application Data
(60) Provisional application No. 61/230,704, filed on Aug. 1, 2009.

(51) Int. Cl. G09B 23/28

(52) U.S. Cl. 434/262

(57) ABSTRACT

Disclosed are methods, systems and articles, including a method that includes presenting multimedia data, on a multimedia presentation device, to a user based, at least in part, on input received from the user, the multimedia data including scripted presentation of at least one narrator to present information to the user, and multimedia presentation of one or more learning activities, including one or more challenges. At least one of the one or more challenges is based on information provided via the multimedia presentation including via the at least one narrator, the multimedia presentation including medical information. The method also includes controlling, based at least in part on responsiveness of the user's input, the presentation of the multimedia data to enhance learning by the user of the medical information, the controlled presentation resulting from the user's input being independent and non-interactive with the scripted presentation of the at least one narrator.

### CROSS-REFERENCE TO RELATED APPLICATION

The present application claims benefit and priority to U.S. Provisional Patent Application No. 61/230,704, filed on Aug. 1, 2009, entitled “Device, Method and System for Interactive Learning/Education of Diabetes and Insulin Pumps”, the disclosure of which is herein incorporated by reference in its entirety.

### FIELD

Various embodiments described herein relate generally to the field of healthcare learning and/or education. In particular, some embodiments relate to methods, systems and devices for educating patients, users, caregivers and others (e.g., parents of patients) about diabetes via an interactive presentation application, such as, for example, a computer game. More particularly, systems, device, and methods described herein enable users to learn independently about diabetes and how to use insulin pumps.

### BACKGROUND

Diabetes mellitus is a disease of major global importance, increasing in frequency at almost epidemic rates, such that the worldwide prevalence in 2006 is 170 million people and predicted to at least double over the next 10-15 years. Diabetes is characterized by a chronically raised blood glucose concentration (hyperglycemia), due to, for example in diabetes type 1, a relative or absolute lack of the pancreatic hormone, insulin. Within the healthy pancreas, beta cells, located in the islets of Langerhans, continuously produce and secrete insulin according to the blood glucose levels, maintaining near constant glucose levels in the body.

Much of the burden of the disease to the user/patient and to health care resources is due to the long-term complications, which affect both small blood vessels (microangiopathy, causing eye, kidney and nerve damage) and large blood vessels (causing accelerated atherosclerosis, with increased rates of coronary heart disease, peripheral vascular disease and stroke). The Diabetes Control and Complications Trial (DCCT) demonstrated that development and progression of the chronic complications of diabetes are greatly related to the degree of altered glycemia as quantified by determinations of glycohemoglobin (HbA1c) [DCCT Trial, N Engl J Med 1993; 329: 977-986, UKPDS Trial, Lancet 1998; 352:837-853. BMJ 1998; 317, (7160): 703-13 and the EDIC Trial, N Engl J Med 2005; 353, (25): 2643-53]. Thus, maintaining normoglycemia by frequent glucose measurements and corresponding adjustment of insulin delivery commensurate with measured glucose levels is important.

Frequent insulin administration can be done by multiple daily injections (MDI) with a syringe or by continuous subcutaneous insulin injection (CSII) carried out by insulin pumps. In recent years, ambulatory portable insulin infusion pumps have emerged as a superior alternative to multiple daily injections of insulin. These pumps can deliver insulin at a continuous basal rate as well as in bolus volumes. Generally, they were developed to liberate patients from repeated self-administered injections, and to allow greater flexibility in dose administration.

Insulin pumps have been available and can deliver rapid acting insulin 24 hours a day through a catheter placed under the skin (subcutaneously). The total daily insulin dose can be divided into basal and bolus doses. Basal insulin can be delivered continuously over 24 hours, and keeps the blood glucose concentration levels (namely, blood glucose levels) in normal desirable range between meals and overnight. Diurnal basal rates can be pre-programmed or manually changed according to various daily activities.

Learning to function with diabetes and/or learning to operate and adapt to using an insulin delivery device, such as an insulin pump, requires training and educating the patient, as well as other persons who may need to be trained and educated about the condition affecting the patient and the treatments for that condition.

### SUMMARY

Embodiments of the present disclosure relate to presentation and learning systems to control presentation of multimedia data. In some embodiments, the data whose presentation is to be controlled includes medical data, including data pertaining to medical conditions and treatments therefor, data pertaining to health care education, etc.

In some embodiments, the systems, methods and devices described herein include an interactive learning presentation system to teach and educate proper management of diabetes, the advantages of managing diabetes using a pump (such as the Solo™ pump manufactured by Medingo Ltd. of Israel), and demonstrating various insulin delivery options provided by insulin pumps. The presentation systems described herein also enable educating suitable behaviors for managing diabetes in different physical situations, including teaching how a physical situation influences the blood sugar levels, appropriate responses to changes in blood sugar levels, and how pumps (such as the Solo™ pump) help users to accomplish the required response easily and efficiently. The disclosed systems, methods, and devices may also be configured to educate/train about other medical conditions, as well as about non-medical subject matter.

In some embodiments, a system, method and/or device are provided that enable education of patients, users, caregivers (physicians, Certified Diabetes Educators (“CDEs”)) and others (e.g., parents of patients), hereinafter referred-to as “users”, about diabetes, as well as other information regarding diabetes (e.g., its reasons, origin, implications, complications, methods of diagnosis and methods of treatment).

In some embodiments, a system, method and/or device are provided that enable education of users about diabetic related devices and systems (e.g., insulin pumps, glucometers, Continuous Glucose Monitors (“CGMs”), diabetes-related software programs, carbohydrate counting guides), by providing them the knowledge to use these devices/systems in a more efficient and correct manner to improve their health condition.

In some embodiments, a system, method and/or device is provided to enable education of users in diabetes related matter. In some embodiments, these devices, systems and methods include interactive simulation which enables self-learning. In some embodiments, these devices, systems and methods can include an interactive computer games or courseware, which facilitate the learning experience by employing simple interaction for grownups, children, disabled users and the like. As used herein, the term “game” may also refer to “courseware”, “learning application”, “e-learning”, “means for educational environment”, etc. In some embodiments, these devices, systems and methods can be implemented using software executing on one or more processor-based devices such as a laptop, a Personal Data Assistance (“PDA”), a media player (e.g., iPod, iPhone, iPad), a PC, a cellular phone, a watch, an insulin pump and/or its remote control, a remote server(s), internet/web, etc.

In some embodiments, a multi-media medical presentation method for enhanced learning of medical information is disclosed. The method includes presenting multimedia data, on a multimedia presentation device, to a user based, at least in part, on input received from the user, the multimedia data may include presentation (e.g., scripted presentation) of at least one narrator to present information to the user, and multimedia presentation of one or more learning activities, including one or more challenges. At least one of the one or more challenges is based on information provided via the multimedia presentation including via the at least one narrator, the multimedia presentation including medical information. The method also includes controlling, based at least in part on responsiveness of the user's input, the presentation of the multimedia data to enhance learning by the user of the medical information. In some embodiments, the controlled presentation resulting from the user's input may be independent and non-interactive with the scripted presentation of the at least one narrator.

Embodiments of the method may include any of the features described in the present disclosure, as well as any one or more of the following features.

The one or more learning activities may include one or more of, for example, presentation of animated trivia games, presentation of question-based games, presentation of animated explanatory graphs, presentation of written explanations, presentation of audible dialogs/explanations, presentation of calculation tasks, and/or presentation regarding implementing therapy using a medical device.

The one or more learning activities may include knowledge implementation learning activities, including one or more challenges based on information provided via the multimedia presentation.

The knowledge implementation learning activities may include one or more multiple choice questions.

The one or more challenges may include one or more of, for example, selecting a remedy from a plurality of possible remedies to treat a medical condition presented, the selected remedy causing presentation of multimedia data associated with the effect of the selected remedy to treat the condition, selecting an answer from a plurality of possible answers to a presented question, the selected answer causing presentation of multimedia information responsive to the selected answer, selecting one or more items from a plurality of items in response to presentation of data prompting selection of items meeting one or more criteria, and/or determining an answer in response to a presentation of a calculation task.

The multimedia data may include a virtual environment in which the at least one narrator operates.

The virtual environment may include one or more selectable areas, the one or more selectable areas comprise presentation of the one or more learning activities. The one or more selectable areas may correspond to one or more aspects of the medical information. The one or more aspects of the medical information may be associated with at least one of, for example, delivery of insulin basal doses, delivery of insulin bolus doses, insulin delivery during physical activity, insulin delivery during illness, insulin delivery during sleeping, hyperglycemia, hypoglycemia, and/or life with diabetes.

The virtual environment may include graphical representation of a house including one or more rooms, each of the one or more rooms being representative of corresponding aspects of the medical information, wherein selection of at least one of the one or more rooms causes an enlarged presentation of the selected at least one of the one or more rooms and presentation of the corresponding aspects of the medical information, the presentation of the corresponding aspects of the medical information including presentation of at least one of the one or more learning activities associated with the selected at least one of the one or more rooms.

Selection of at least one other of the one or more rooms may be based on level of responsiveness such that when the level of responsiveness is indicative that at least one of the one or more challenges required to be completed before multimedia data associated with at least one other of the one or more rooms can be presented have not been completed. In some embodiments, the selection of the at least one other room may cause a graphical presentation of a locked room and/or presentation of information indicating that the at least one of the one or more challenges is required to be completed.

Controlling the presentation of the multimedia data may be based, at least in part, on prior knowledge of the user.

In some embodiments, at least one of the challenges may be based, at least in part, on prior knowledge of the user.

The method may further include determining level of responsiveness of the user's input to one or more of the challenges.

Determining the level of responsiveness may include determining whether the user provided proper response to the one or more challenges based on a pre-determined criteria.

Determining the level of responsiveness may include one or more of, for example, the following: determining whether the user provided proper response to the one or more challenges, determining a number of successful responses to the one or more challenges, and/or determining whether the number of successful responses matches a pre-determined threshold.

Controlling the presentation of the multimedia data may be based, at least in part, on the determined level of the responsiveness.

Controlling the presentation of the multimedia data may include one or more of, for example, presenting reasons why the user's response input to a particular one of the one or more challenges is not proper when the user fails to properly complete the particular one of the one or more challenges, presenting to the user reinforcement information when the user successfully completes the particular one of the one or more challenge, and/or enabling presentation of multimedia data according to a number of successful responses that matches a pre-determined threshold.

The level of responsiveness may include data representative of graphical certificates that are each associated with completion of at least one of the one or more challenges, and data identifying the respective at least one of the one or more challenges.

The data representative of graphical certificates may include one or more of, for example, a micropump image, a stamp image and/or a game certificate.

The method may further include recording, to a memory device, the level of responsiveness of the user's input to the one or more of the challenges.

The method may further include presenting the recorded level of responsiveness in the presentation, for example, in a presentation ending multimedia data.

Controlling the presentation of the multimedia data may include presenting presentation-ending multimedia data in response to a determination that the level of responsiveness matches a value corresponding to successful responses to a pre-determined number of the one or more challenges.

The pre-determined number may include all the one or more challenges.

The medical information may include information about diabetes and treatment of diabetes using an insulin pump. The medical information may include information about using a glucose monitor (e.g., a glucometer) for diabetes.

The at least one narrator may be configured to present the medical information to the user using visual and/or audio presentation.

The at least one narrator may be configured to initiate a monolog addressing the user.

In some embodiments, the method may be implemented on a processor-based device, including, for example, a processor, a memory and a user interface (e.g., a screen, a keyboard, pointing device).

In some embodiments, the method may include validating learning of the medical information by the user. Validating may include recording the user's level of responsiveness and then retrieving the level of responsiveness to track user's learning of the medical information.

In some embodiments, a multi-media medical presentation system for enhanced learning of medical information is disclosed. The system includes a multimedia presentation device, one or more processor-based devices in communication with the multimedia presentation device, and one or more non-transitory memory storage devices in communication with the one or more processor-based devices. The one or more memory storage devices store computer instructions that, when executed on the one or more processor-based devices, cause the one or more processor-based devices to present multimedia data, on the multimedia presentation device, to a user based, at least in part, on input received from the user, the multimedia data including scripted presentation of at least one narrator to present information to the user, and multimedia presentation of one or more learning activities, including one or more challenges. At least one of the one or more challenges is based on information provided via the multimedia presentation including via the at least one narrator, the multimedia presentation including medical information. The computer instructions further cause the one or more processor-based devices to control, based at least in part on responsiveness of the user's input, the presentation of the multimedia data to enhance learning by the user of the medical information, the controlled presentation resulting from the user's input being independent and non-interactive with the scripted presentation of the at least one narrator.

Embodiments of the system may include any of the features described in the present disclosure, including any of the features described above in relation to the method.

In some embodiments, a computer program product to facilitate enhanced learning of medical information is disclosed. The computer program product includes instructions stored on one or more non-transitory memory storage devices, including computer instructions that, when executed on one or more processor-based devices, cause the one or more processor-based devices to present multimedia data, on a multimedia presentation device, to a user based, at least in part, on input received from the user, the multimedia data including scripted presentation of at least one narrator to present information to the user, and multimedia presentation of one or more learning activities, including one or more challenges. At least one of the one or more challenges is based on information provided via the multimedia presentation including via the at least one narrator, the multimedia presentation including medical information. The computer instructions further cause the one or more processor-based devices to control, based at least in part on responsiveness of the user's input, the presentation of the multimedia data to enhance learning by the user of the medical information, the controlled presentation resulting from the user's input being independent and non-interactive with the scripted presentation of the at least one narrator.

Embodiments of the computer program product may include any of the features described in the present disclosure, including any of the features described above in relation to the method and the system.

In some embodiments, a multi-media medical presentation system for enhanced learning of medical information is disclosed. The system includes a multimedia presentation means, one or more processor-based means in communication with the multimedia presentation means, and one or more non-transitory memory storage means in communication with the one or more processor-based means. The one or more memory storage means store computer instructions that, when executed on the one or more processor-based means, cause the one or more processor-based means to present multimedia data, on the multimedia presentation means, to a user based, at least in part, on input received from the user, the multimedia data including scripted presentation of at least one narrator to present information to the user, and multimedia presentation of one or more learning activities, including one or more challenges. At least one of the one or more challenges is based on information provided via the multimedia presentation including via the at least one narrator, the multimedia presentation including medical information. The computer instructions further cause the one or more processor-based means to control, based at least in part on responsiveness of the user's input, the presentation of the multimedia data to enhance learning by the user of the medical information, the controlled presentation resulting from the user's input being independent and non-interactive with the scripted presentation of the at least one narrator.

Embodiments of the system may include any of the features described in the present disclosure, including any of the features described above in relation to the method and/or other systems.

Details of one or more embodiments are set forth in the accompanying drawings and in the description below. Further features, aspects, and advantages will become apparent from the description, the drawings, and the claims.

### BRIEF DESCRIPTION OF THE DRAWINGS

FIG. 1 is a schematic diagram of an implementation of a presentation system.

FIG. 2 is a flow chart of a procedure to control presentation of information (e.g., medical information).

FIG. 3 is a flow diagram of an example interactive learning procedure.

FIG. 4 is a flow diagram of an example presentation procedure to present multimedia data for a particular area of a virtual environment.

FIG. 5 is a flow diagram for an example presentation procedure to present multimedia data in relation to a “stamp” challenge for a particular area of a virtual environment.

FIG. 6 is a screenshot of an example navigation map of a virtual environment.

FIG. 7 is a screenshot of an example graphical rendering of a basement area in a house-based virtual environment.

FIG. 8 is a screenshot of an example rendering of a selected item from a room of the virtual house.

FIG. 9 is a screenshot of an example challenge.

FIG. 10 is a screenshot of an example multiple choice question.

FIG. 11 is a screenshot of an example certificate award.

FIG. 12 is a screenshot of an example game certificate.

FIG. 13 is a screenshot of an example award indicating the user's completion of a learning activity.

FIG. 14 is a screenshot of an example explanation provided in response to an improper user response to a challenge.

FIG. 15 is a screenshot of an example reinforcement information content provided in response to a proper user response to a challenge.

FIG. 16 is a screenshot of a congratulatory certificate.

FIG. 17 is a screenshot of example narrator images.

FIG. 18 is a screenshot of an example personal data form.

FIG. 19 is a screenshot of an example opening screen introducing the game's virtual environment.

FIG. 20 is a screenshot of an example graphical rendering of a living room area in a house-based virtual environment.

FIG. 21 is a screenshot of an example graphical rendering of a kitchen area in a house-based virtual environment.

FIG. 22 is a screenshot of an example graphical rendering of a dining room area in a house-based virtual environment.

FIG. 23 is a screenshot of an example graphical rendering of a gym area in a house-based virtual environment.

FIG. 24 is a screenshot of an example graphical rendering of a bathroom area in a house-based virtual environment.

FIG. 25 is a screenshot of an example graphical rendering of a bedroom area in a house-based virtual environment.

FIG. 26 is a screenshot of an example learning activity describing operation of therapy device.

FIG. 27 is a screenshot of an example learning activity in the form of an animated explanatory graph.

FIG. 28 is a screenshot of an example learning activity in the form of written explanations.

FIG. 29 is a screenshot of an example learning activity in the form of a calculation task.

### DETAILED DESCRIPTION

Systems, devices and methods for presenting data to enable learning and/or to educate about medical conditions (e.g., diabetes) and treating such conditions (e.g., using diabetes related devices/systems and methods) are provided. In some embodiments, a multimedia medical presentation method for enhanced learning of medical information is provided, that includes presenting multimedia data on a multimedia presentation device to a user, based, at least in part, on input received from the user, where the multimedia data including scripted presentation of at least one narrator to present information to the user, and presentation of one or more learning activities, including one or more challenges that are based on information provided through the multimedia presentation including through the at least one narrator, the multimedia presentation including medical information.

The method further includes controlling, based, at least in part, on the responsiveness of the user's input, the presentation of the multimedia data to enhance learning by the user of the medical information. The controlled presentation resulting from the user's response input being independent and non-interactive with the scripted presentation of the at least one narrator. In some embodiments, the controlled presentation of the multimedia data based on the responsiveness of the user's response input includes presenting reasons the user's response input to a particular one of the one or more challenges are not proper when the user fails to properly complete the particular one of the one or more challenges, and presenting to the user reinforcement information when the user successfully completes the challenge.

In some embodiments, the multimedia data may include, for example, a virtual environment (in which the at least one narrator operates) that includes graphical representation of a house including one or more rooms, with each of the one or more rooms being representative of corresponding aspects of the medical information. For example, the basement (which may symbolize the base or foundations of the house) may correspond to information about basal insulin (which may symbolize the base profile delivery of insulin delivery). In some embodiments, selection of at least one of the one or more rooms causes a presentation (e.g., an enlarged presentation) of the selected at least one of the rooms and presentation of corresponding aspects of the medical information. The presentation of the corresponding aspects of the medical information can include presentation of learning activities from the one or more learning activities associated with the selected at least one of the one or more rooms.

Other virtual environments are also contemplated by embodiments of the present disclosure including, for example, a castle, a commercial building, a factory, a maze, a space shuttle, and an amusement park. Still, other virtual environments may include sporting events and associated structures, e.g., baseball and a baseball field/stadium, football and a football field/stadium, and the like.

In some embodiments, the method may further optionally include determining a level of responsiveness of user's response input to the one or more challenges.

In some embodiments, diabetes related devices can include therapeutic fluid (e.g., insulin, Symlin®) infusion devices such as for example pumps (e.g., pager-like pumps, patch pumps and micro-pumps), pens, jets, and syringes. Examples for such infusion devices are disclosed in international application no. PCT/IL2009/000388, and U.S. publication no. 2007/0106218, the disclosures of which are incorporated herein by reference in their entireties. Such infusion devices/systems may include systems including a dispensing unit (e.g., a pump), a remote control unit, and/or a blood glucose monitor. In some embodiments, the dispensing unit may be connected to a cannula that penetrates a patient's skin to deliver insulin to the subcutaneous tissue, and may include a single part having a single housing, or two parts (e.g., a reusable and a disposable part) having two separate connectable housings. In some embodiments, these devices/systems can include analyte (e.g., glucose) sensing devices such as for example glucometer devices, blood sugar strips, and continuous glucose monitors (CGMs). Examples for such sensing devices are disclosed, for example, in U.S. publication Nos. 2007/0191702 and 2008/0214916, the disclosures of which are incorporated herein by reference in their entireties. In some embodiments, these devices can include, for example, features for bolus dose recommendations and features for basal profiles determination. In some embodiments, diabetic related methods can include methods for Carbohydrate-to-Insulin Ratio (“CIR”) estimations, Insulin Sensitivity (“IS”) estimations, and the like. In some embodiments, these devices, systems and methods can include an interactive learning application (e.g., a computer game, a courseware, a video game) to enable education and training of users to use these devices and learn about diabetes.

In some embodiments, the interactive learning application may be provided in conjunction with these devices (e.g., a CD which may be provided with the device(s) package(s)), and/or provided via the caregivers (e.g., CDEs, physicians) and/or via a website corresponding to the device(s), in order to facilitate training on using these devices. In some embodiments, the learning application may be provided to the user as part of the user interface of these devices (e.g., displayed, for example, on an insulin pump's remote control screen), as an educational feature/tool. The application may run automatically upon first activation or use of these devices (e.g., an insulin pump) to ensure hands-on training when using the device.

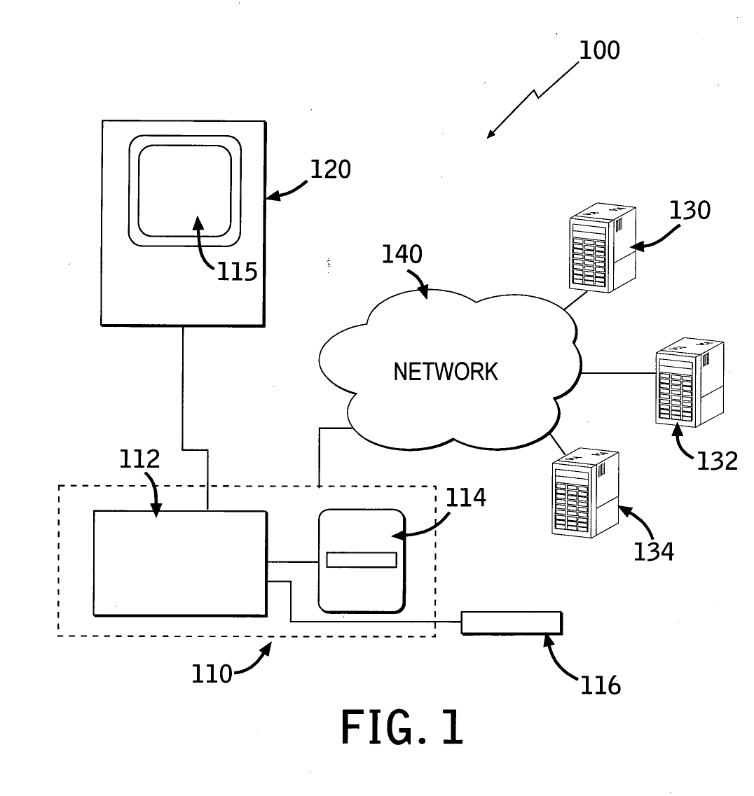

With reference to FIG. 1, a schematic diagram of an example embodiment of a presentation system 100 to enable enhanced learning of various subject matters, including medical/health-related subject matters such as diabetes and treatments for diabetes, is shown. The presentation system 100 includes at least one processor-based device 110 such as a personal computer (e.g., a Windows-based machine, a Mac-based machine, a Unix-based machine, etc.), a specialized computing device, and so forth, that typically includes a processor 112 (e.g., CPU, MCU). In some embodiments, the processor-based device may be implemented in full, or partly, using an iPhone™, an iPad™, a Blackberry™, or some other portable device (e.g., smart phone device), that can be carried by a user, and which may be configured to perform remote communication functions using, for example, wireless communication links (including links established using various technologies and/or protocols, e.g., Bluetooth). In addition to the processor 112, the system includes at least one memory (e.g., main memory, cache memory and bus interface circuits (not shown)). The processor-based device 110 can include a storage device 114 (e.g., mass storage device). The storage device 114 may be, for example, a hard drive associated with personal computer systems, flash drives, remote storage devices, etc.

Content of the information presentation system 100 may be presented on a multimedia presentation (display) device 120, e.g., a CRT (cathode ray tube) or LCD (liquid crystal display) monitor, a plasma monitor, etc. Other modules that may be included with the system 100 are speakers and a sound card (used in conjunction with the display device to constitute the user output interface). A user interface 115 may be implemented on the multimedia presentation (display) device 120 to present multimedia data based, at least in part, on input provided by the user (e.g., selecting a particular area of a presented virtual environment to cause multimedia content to be retrieved and presented). In some embodiments the user interface 115 may comprise a keyboard 116 and a pointing device, e.g., a mouse, a trackball (used in conjunction with the keyboard to constitute the user input interface). In some embodiments, the user interface 115 may comprise touch-based GUI by which the user can provide input to the presentation system 100.

In some embodiments, the presentation system 100 is configured to, when executing, on the at least one processor-based device, computer instructions stored on a memory storage device (for example) or some other non-transitory computer readable medium, implement a controlled presentation of multimedia content. Such content may include a presentation of interactive multimedia content in which a user may acquire information via the multimedia presentation (for example) and then be asked to perform interactive operations facilitated by the presentation system 100.

In some embodiments, the multimedia presentation may include at least a scripted audio-visual presentation, which may include presentation of a narrator delivering explanations and information in relation to the presented subject matter (such as explanation about diabetes, treatments therefor and/or information about other health-related topics). In some embodiments, the multimedia data presented using the system 100 may also include one or more learning activities (such activities may include one or more challenges) that are based on information provided through the multimedia presentation (including the presentation by the narrator). In some embodiments, the one or more learning activities (or at least part of the one or more learning activities) may be based on previous knowledge of the user, such as for example common knowledge of diabetic patients.

As will become more apparent below, the system 100 may be configured to control the presentation of the multimedia data based on responsiveness of a user to at least one of the one or more challenges presented via the system 100. For example, when it is determined that the user provided an improper response (e.g., a wrong answer/solution) to a challenge, resultant multimedia data that may include reasons presented to the user (for example, through an audio-visual or visual presentation presented on the user interface 115, e.g., a screen) why the response given by the user is incorrect or improper may be presented. In another example, when a user provides a proper response to a challenge, reinforcement information may be presented to the user (to further entrench the information into the user's mind and to encourage user to continue and learn).

In some embodiments, the multimedia data controllably presented based, at least in part, on the user's input (including responsiveness to the one or more challenges), is independent and non-interactive with the scripted presentation of the at least one narrator used in the multimedia presentation. Thus, the user may not interact or otherwise control the behavior of the at least one narrator used in the multimedia presentation or any other actual content of the scripted presentation. However, in some embodiments, the user's input may be used to determine the sequence and/or timing that a particular portion of the narrator's multimedia presentation is presented, but not what or how it is presented, for example. In other words, in such embodiments, the user may select which aspect of the information he/she wants to view or hear, and thus may cause a particular segment of the multimedia data to be presented instead of some other segments. However, the user may not control what and how the data is presented, for example the user may not be able to operate the at least one narrator.

As noted, the storage device 114 may include thereon computer program instructions that, when executed on the at least one processor-based device 110, perform operations to facilitate the implementation of controlled presentation procedures, including implementation of an interface to enable presentation of the multimedia to enhance learning of medical information. In some embodiments, the presentation of the multimedia may be performed visually (e.g., via a screen/display), audibly (e.g., via speakers, buzzer) and/or sensorially (e.g., via a scent spray, a vibrating device).

The at least one processor-based device may further include peripheral devices to enable input/output functionality. Such peripheral devices include, for example, a CD-ROM drive, a flash drive, or a network connection, for downloading related content to the connected system. Such peripheral devices may also be used for downloading software containing computer instructions to enable general operation of the respective system/device, as well as to enable retrieval of multimedia data from local or remote data repositories and presentation and control of the retrieved data.

In some embodiments, special purpose logic circuitry, e.g., an FPGA (field programmable gate array) or an ASIC (application-specific integrated circuit) may be used in the implementation of the presentation system 100. The at least one processor-based device 110 may include an operating system, e.g., Windows XP® Microsoft Corporation operating system. Alternatively, other operating systems could be used. Additionally and/or alternatively, one or more of the procedures performed by the presentation system may be implemented using processing hardware such as digital signal processors (DSP), field programmable gate arrays (FPGA), mixed-signal integrated circuits, etc. In some embodiments, the processor-based device 110 may be implemented using multiple inter-connected servers (including front-end servers and load-balancing servers) configured to store information pulled-down, or retrieved, from remote data repositories hosting content that is to be presented on the user interface 115.

The various systems and devices constituting the system 100 may be connected using conventional network arrangements. For example, the various systems and devices of system 100 may constitute part of a public (e.g., the Internet) and/or private packet-based network. Other types of network communication protocols may also be used to communicate between the various systems and devices. Alternatively, the systems and devices may each be connected to network gateways that enable communication via a public network such as the Internet. Network communication links between the systems and devices of system 100 may be implemented using wireless or wire-based links. For example, in some embodiments, the system may include communication apparatus (e.g., an antenna, a satellite transmitter, a transceiver such as a network gateway portal connected to a network, etc.) to transmit and receive data signals. Further, dedicated physical communication links, such as communication trunks may be used. Some of the various systems described herein may be housed on a single processor-based device (e.g., a server) configured to simultaneously execute several applications. In some embodiments, the presentation system 100 may retrieve data from one or more remote servers that host data repositories of the one or more subject matters with respect to a user accesses information presented on the user interface 115. FIG. 1 depicts three servers 130, 132 and 134 from which the system 100 may retrieve data. Additional or fewer (or none at all) servers may be used with the system 100. The system 100 and the servers 130, 132 and 134 may be interconnected via a network 140.

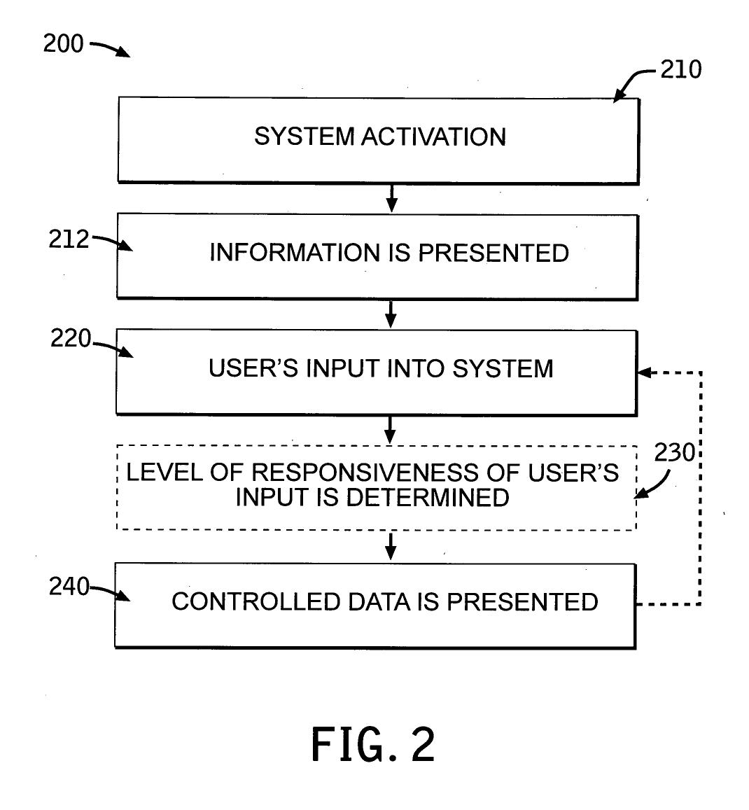

Referring to FIG. 2, a flow diagram of procedure 200 to present multimedia information (e.g., medical information), to enhance learning of that information according to some embodiments is shown. Generally, a user having access to a computing device may invoke a locally installed presentation system, or may access a remote presentation system. As noted herein, at least part of the system 100 may be implemented using software executing on a remote processor-based device. Such a software implementation may be a web-based application to control presentation of multimedia content. In some embodiments, such a remote processor-based device may send data as JavaScript messages, and/or markup language messages (e.g., HTML, Extended Markup Language, etc.) In such embodiments, the accessed server may retrieve data requested by the user from a local storage device or from a remote storage device (in situations where a data repository of multimedia data is implemented as a distributed system), format the data content using, for example, one or more types of markup languages, and transmit the formatted data back to the user's station, whereupon the data can be presented on, for example, a web browser. In some embodiments, the data and/or information may be presented using animation (e.g., an animated film, a Flash cartoon). The animation may be implemented using animation software, such as for example, Adobe® Flash®, and may include audio and/or visual presentations.

Where implemented on an Internet browser, such as Internet Explorer®, the entire presentation of the multimedia data may be rendered within the display area of the browser. The content to be presented may thus be specified using, for example, Semantic HTML syntax. In some embodiments, JavaScript, or some other scripting language, may be used to control the behavior and operation of the content being presented. Additionally, embodiments may also be realized using various programmable web browser plugins.

As noted, in some embodiments, the presentation system may be implemented as a dedicated software application, e.g., a proprietary software implementation developed to enable presentation of content. The interface can thus be implemented, for example, as an application window operating on an MS-Windows platform, or any other type of platform that enables implementation of graphical user interfaces. In circumstances where the interface is implemented as a window, the interface can be designed and presented using suitable programming languages and/or tools, such as Visual Basic, that support the generation and control of such interfaces. Where a dedicated software application is developed to implement the system and its interface, the retrieved data may be formatted or coded to enable the data's presentation in the desired manner.

Thus, following system activation 210, multimedia data pertaining to, for example, medical information such as information about diabetes and treatment for it, is presented 212 on a multimedia presentation device such as the device 120 depicted in FIG. 1. The multimedia data may be presented based, at least in part, on user's input 220 into the system.

As will be discussed in greater detail below, in some embodiments, the multimedia presentation renders a virtual environment (such as a house) through which the user may navigate. Such a virtual environment may be divided into several scenes (such as rooms in the house, e.g., a basement), each one of them representing a different topic (or aspect or field of knowledge) of the presented information (e.g., different aspects of a diabetes therapy). Each scene/topic may include a plurality of sub-topics (which may be presented as items within the rooms, for example a washing machine representing temporary basal profiles). Each sub-topic may comprise learning activities for facilitating learning of knowledge corresponding to the subtopic, as described in further detail herein. The user may navigate through the topics and sub-topics for controlling the presentation. Thus, the user may control what rooms in the house are visited (and thus presented) and the particular multimedia information associated with the visited rooms. Accordingly, in the example of the house-based virtual environment, the user's input 220 regarding the room to be visited controls which portions of the overall presentation are presented in response to that selection.

As further described herein, in some embodiments, the multimedia presentation may include at least one narrator (e.g., virtual narrator) that conveys at least some of the information to be presented. The multimedia presentation of the narrator may employ various presentation techniques, including an interaction with animated and/or fanciful characters, use of diagrams, charts, animation, video clips, etc., to make the presentation lively and interesting to the user and to thus facilitate the learning process.

The multimedia data presented includes one or more learning activities that may include one or more challenges that are based, at least partly, on information presented to the user, including information conveyed through the narrator. These challenges may be used to facilitate the user's learning of the information by enabling the user, e.g., through the one or more challenges, to apply the information presented to tackle and solve the challenges. In some embodiments, some of the challenges may be based, at least partly, on prior knowledge or common knowledge/information of the user. Such common/prior information has not been explicitly presented by the system. Some of the challenges presented to the user may include one or more of, for example, selecting a remedy from a plurality of possible remedies to treat a medical condition presented (in some embodiments, the selected remedy causes presentation of multimedia data associated with the effect of the selected remedy to treat the condition), selecting an answer from a plurality of possible answers to a question (e.g., by pointing, clicking, dragging, scrolling an image), selecting one or more items from a plurality of items in response to presentation of data prompting selection of items meeting one or more criteria, and/or calculating and/or inputting (e.g., typing) an answer to a question (or a solution to a problem).

With continued reference to FIG. 2, where user's input 220 is required as part of the ongoing multimedia presentation, a level of responsiveness of the user's response input is optionally determined 230. For example, in some embodiments, the user may interact, through the user interface to navigate through the rendered virtual environment. For example, various screens of the presented content may include selectable items enabling the user to specify (e.g., by clicking an icon, entering text-based input in fields rendered on the interface) which part of the presentation the user wishes to view. Under those circumstances, the determined level of responsive may include determining what input was received from the user, and responding to the user's input accordingly, e.g., selection by the user of an icon to proceed to a different room may cause retrieval of the appropriate multimedia data associated with the selected room (if it is determined, as performed, for example, in operations of the procedure 200, that the user is entitled to proceed to selected room) and commencement of the presentation of the multimedia data associated with the selected room. Level of responsiveness is also determined in circumstances where the user is presented with challenges and responds to those challenges (e.g., by selecting one of several possible answers). Under those circumstances, the determined level of responsiveness includes a determination of whether the user provided the proper response to the presented challenge.

In yet another example, a level of responsiveness may also be determined in situations where navigation within the virtual environment is based on whether the user successfully completed some challenges that are pre-requisites for viewing data accessed through certain areas of the virtual environment. Under these circumstances, determining a level of responsiveness may also include, for example, determining if the user responded to previous presented challenges that are pre-requisite for proceeding to certain parts of the multimedia presentation.

In some embodiments, a certificate/award counter may be maintained to track the number of “certificates” awarded for successful completion of certain portions of the multimedia presentation. Such a counter may be implemented as a data record that can maintain the number of certificates earned, can identify where those certificates were earned (and thus which portions of the multimedia presentation the user completed), etc. Such a record of the certificate/award counter may be stored in a memory. In some embodiments, the stored record may enable, for example, a repetitive use of the presentation, in which the user can halt (e.g., quit) the presentation in a first condition (e.g., a certain level of responsiveness), and then can resume it at a later time, being able to retrieve from the memory, the first condition.

With continued reference to FIG. 2, based, at least in part on the level of responsiveness (as determined, for example, at 230), the presentation of the multimedia data is controlled 240. Control of the multimedia presentation includes, in some embodiments, presenting multimedia content that includes reasons (presented as audio and/or visual content) why the user's response input to a particular challenge was improper or incorrect when the user's fails to properly complete the challenge, and optionally presenting reinforcement information relating to the particular challenge when the user successfully completes the challenge.

As noted herein, in some embodiments, control of the presentation of multimedia data may also include determining which portion of the multimedia presentation to retrieve and present in response to navigation input from the user indicative of, for example, which part of the virtual environment the user wishes to go to. Control of the multimedia presentation may also include causing the presentation of multimedia content in response to user's selection of certain responses to challenges or user's input to available prompts (such as icons, fields, etc.)

In some embodiments, the controlled presentation of the multimedia data resulting from the user's response input is independent and non-interactive with the scripted multimedia presentation of the at least one narrator.

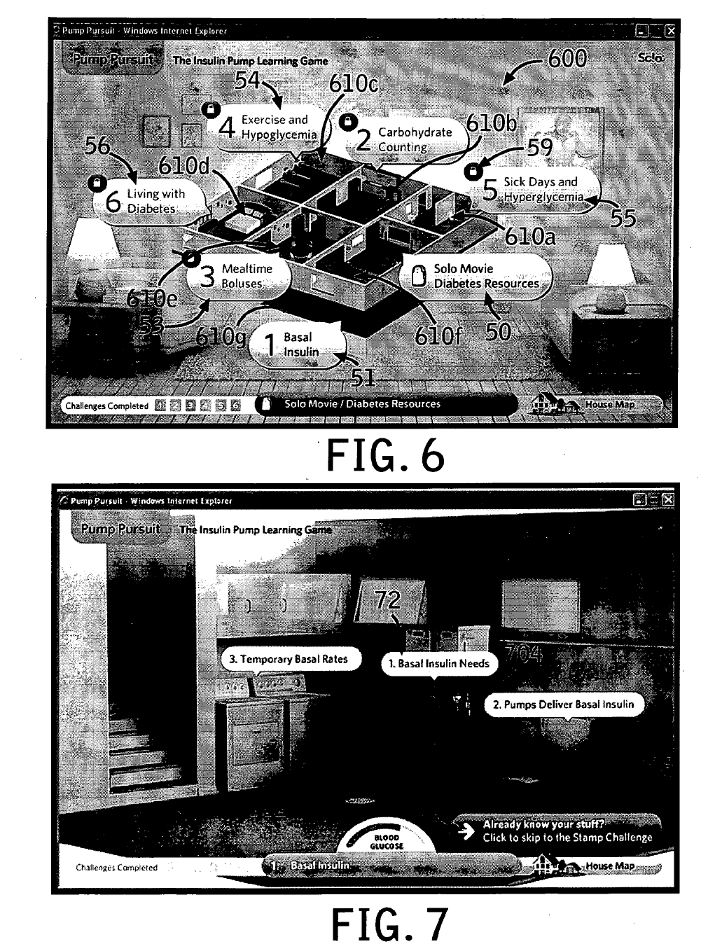

To illustrate operation of the system 100 and/or the procedure 200 described above, a particular example implementation of an interactive learning procedure 300 is shown in FIG. 3. Procedure 300 may, in some embodiments, be implemented using a system such as the system 100, on which a learning application (e.g., web-based or locally executed) that includes an interactive interface, may be running. Alternatively, other embodiments for performing the learning procedure, be it hardware-based and/or software-based, may be used. In describing the procedure 300, reference will be made to FIGS. 6-12, 17-20, which are screenshots of presented multimedia data to facilitate and enhance learning of medical information pertaining to diabetes and treatment of diabetes (for example).

Thus, commencement of the procedure 300 causes the presentation 310 of introduction data to provide, e.g., as an audio-visual presentation, introduction of the medical condition in question and its treatments (therapies). This presentation may be provided as a narrative audio-visual presentation delivered by at least one narrator (examples of narrative dialog are provided in Appendix A). FIGS. 17, 19 and 20 are screenshots (for example) which include introduction data that may be presented (e.g., at 310). In this example, the screenshots (which may be also referred-to as “opening screens” or “introduction screens”) present diabetes as the medical condition, for example, a house as a virtual environment for example, and at least one virtual image as a narrator. FIG. 17 illustrates an example of virtual narrators 12 and 14. The narrators can present the game to the user and/or present learning material using visual and/or audio presentation. In some embodiments, the at least one narrator operating in the virtual environment may be configured to initiate (e.g., simulate) a monolog and/or a dialog (e.g., via a conversation between two narrators) and/or to address the user (e.g., via a monolog addressing the user). In some embodiments, the narrators may illustrate usage of a therapeutic device (e.g., an insulin pump) demonstrating its operation, functionality and advantages of use.

In one example, according to some embodiments of the present disclosure, the narrators may be an “educator” (e.g., an experienced insulin pump user, a caregiver, a Certified Diabetes Educator), and a “trainee” (e.g., a new or inexperienced insulin pump user, a user of MDIs). The introduction may be performed through providing answers, by the educator, to the trainee's questions. In some embodiments, the educator may introduce or explain (via audible presentation) the learning material to be presented throughout the presentation, to enhance the learning process. In some embodiments, the narrators' monologs and/or dialogs therebetween may include playful and humorous content to maintain user's interest and capture his/her attention.

FIG. 19 illustrates an opening screen which includes control elements enabling the user to interactively control the presentation or indicate data relevant to the presentation. For example, element 32 indicates the current/presented presentation, e.g., scene, level, topic such as room no. 1, introduction scene. In this example (illustrated in FIG. 19) element 32 indicates the scene “Solo Movie/Diabetes Resources”. Element 34 indicates the completed scenes/levels/topics or challenges, such as, for example, by indicating the number of gained certificates. Elements 36 and 38 are control elements that enable the user to pause, play or skip the animated movie (including, for example, at least one narrator 12) at his/her discretion. Additional control elements may be presented to the user, including, for example, volume control element and navigation control such as element 30 enabling the user to navigate to a presentation of the “House Map”. Some control elements may be presented according to their relevancy to the presented presentation, such as for example, presenting a progression scale element when a particular learning activity is presented or not presenting a volume control element when sound is not played or is muted. Some elements may be presented based on (or in response) to user's input and/or user's level of responsiveness.

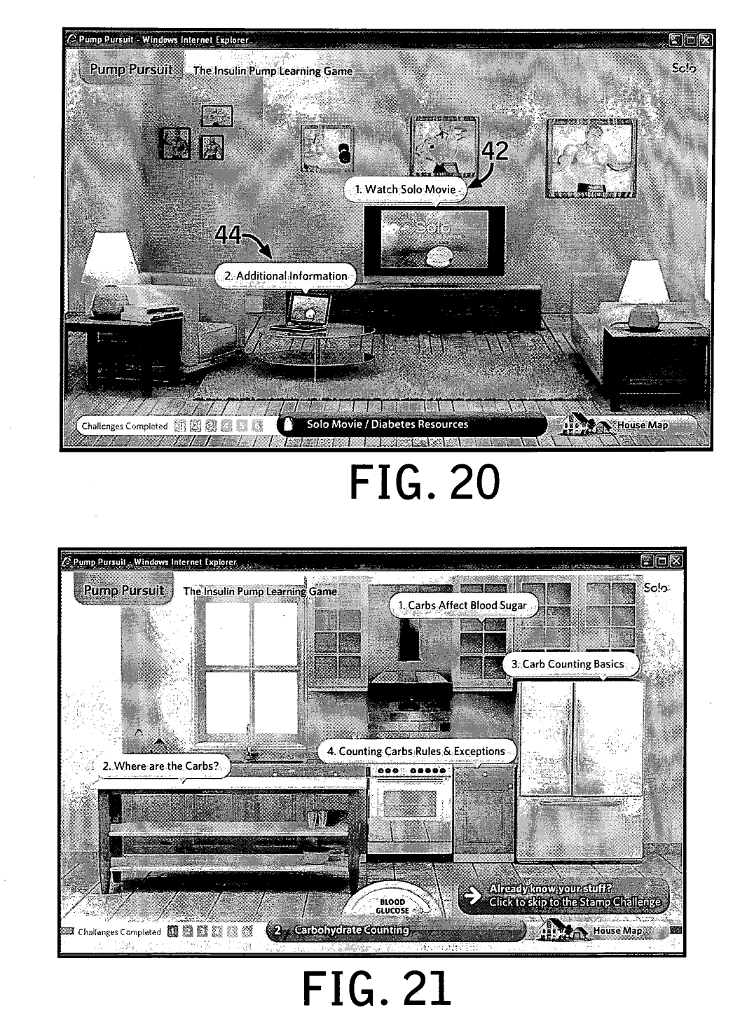

FIG. 20 is a screenshot of a living room (a room in the house) which includes items which introduce the medical information, e.g., diabetes therapy. Particularly, the user can activate an explanatory movie by selecting the “TV screen” element 42. The user can also navigate to other presentations (e.g., websites) which may include additional information related to the medical information. In this example, additional information may include, for example, diabetes related companies' profile, manufacturers, providers and distributors of insulin pumps, an overview of the diabetes market, statistics, personal stories of diabetic patients, etc. Navigating to access this additional information can be done by selecting the “laptop” element 44.

Returning to FIG. 3, upon completion of the introduction presentation 310 (in some embodiments, the user may be able to skip the presentation by selecting a selectable graphical interfacing element such as a “skip” button presented in interface, as also noted above), the main menu and/or a navigation map of a virtual environment may be retrieved and presented 320 on the multimedia presentation device.

Generally, upon completing (or skipping) the introduction presentation 310, a navigation map screen of a virtual environment through which the user can navigate can be presented 320. In some embodiments, the presented content of the navigation map may include menu items (e.g., presented as topics) which provide a description of the nature of the sub-presentation that may be launched by selecting a location or item from the navigation map.

Thus, with reference to FIG. 6, a screenshot of an example navigation map 600 of a virtual environment (in this case, the virtual environment is a house) is shown. The map 600 depicts a layout of a house with one or more rooms 610a-g. The user can navigate to a room by selecting it in the map. For example, navigating to room No. 1 (the basement area) can be done by selecting area 610g or element 51 (containing the description “1. Basal Insulin”). In some embodiments, one or more of the rooms may be locked, and thus, a user may not yet be allowed to access it. A locked room can be represented by a lock symbol, such as the graphical element 59, which may appear next to the room's name (or other descriptive element), (e.g., elements 50-56). When a room is “unlocked”, the symbol 59 does not appear. As illustrated in FIG. 6, the basement area (room No. 1) is “unlocked”. In some embodiments, in order to “unlock” a room, the user has to meet pre-determined criteria, for example completing necessary activities in at least one room (and sometimes in several rooms). In the illustration of FIG. 6, room Nos. 2, 3, 4, 5 and 6 are all locked, and therefore, in order to access them, the user would have had to visit and/or complete learning activities associated with the unlocked rooms of the house virtual environment. In some embodiments, successful completion of one or more rooms may be indicated by an “unlocked” symbol (e.g., “√” symbol) which may appear next to the room's name (or other descriptive element). In some embodiments, all the rooms, part of the rooms, or none of the rooms can be locked. In one example, all the rooms are “unlocked” and available for presentation at any stage of the presentation, so that and the user can select any room at his/her discretion, any time. In some embodiments, enabling “lock” or “unlock” of the rooms is configurable by the user.

Each of the rooms 610a-g may be associated with an aspect (e.g., a topic) of the medical subject matter with respect to which information is being presented to the user(s). In some embodiments, the particular nature of the room may have a playful mental or cognitive association with the subject matter that is representative of the aspect of the subject matter corresponding to the room, or the very nature of the room may be suggestive of the aspect covered by the multimedia data presented when accessing the room. For example, as illustrated, the basement area 610g (room No. 1) deals with “basal insulin” aspect of the information being presented to the user (because basal insulin treatment can be referred-to as the base/foundation for diabetes treatment and/or because the word “basement” is phonetically similar to “basal”). The basement area in the virtual house, which may be reached by selecting region 610g in the screen (e.g., clicking on that region using a mouse), or by clicking in element 51, may include information on basal insulin when the subject matter presented is diabetes. In other examples, information provided through the multimedia content presented in a kitchen area 610b (room No. 2) shown in the map 600 may pertain to diet and carbohydrate counting (because the kitchen is where food, and thus carbohydrate sources, are stored, prepared and obtained), and information provided through the multimedia content presented in a gym area 610c (room No. 4) shown in the map 600 may pertain to delivery of insulin during performance of physical activity (e.g., sports).

As noted, in some embodiments, selection of at least one of the areas in the navigation map (e.g., selection of at least one of the rooms in the map corresponding to a house-based virtual environment) may be prevented if the user can only navigate to that area of the virtual environment if one or more other areas of the environment have first been visited. For example, in some embodiments, the user may be prevented from accessing one of the rooms of the house (e.g., the bedroom) if some pre-requisite rooms (e.g., the basement) have not yet been visited. Therefore, selection of (i.e., navigation to) at least one of the areas of the virtual environment may be based on an indication (determined, for example, based on a user's responsiveness value maintained for the user) that other areas of the virtual environment have been previously selected (thus indicating that the user has completed the presentations and/or learning corresponding to those areas of the virtual environment). In response to selection of an area that cannot be navigated to until other areas of the virtual environment are first visited, a graphical representation indicating that the selected area cannot yet be accessed is provided. For example, selection of a room in the house-based virtual environment that may not be accessed may result in the graphical presentation of a locked room and/or the presentation of additional information (visual and/or audible) explaining why the room cannot yet be visited.

When an area of the virtual environment (e.g., a room of the house-based environment) that may be visited is selected, the current presentation of the navigation map is replaced with a presentation of the selected area of the virtual environment (which may be an enlargement of a miniaturized multimedia presentation of the area as it appears in the navigation map). For example, selection of the basement 610g in the map 600 may causes a presentation of multimedia data that includes a graphical rendering of a basement (which may be an enlargement of a miniaturized multimedia presentation of the basement as it appears in the navigation map). FIG. 7 is a screenshot of a graphical rendering of a basement 700 in the house-based virtual environment.

The selected area of the virtual environment rendering appearing in the user interface may be interactive and may be divided into portions whose selection results in the retrieval and presentation of associated data corresponding to a sub-topic of the specific aspect dealt with in the selected area of the virtual environment (as shown in FIG. 3 step 322). For example, as shown in FIG. 7, the basement includes several items, juxtaposed next to descriptive text, that are associated with sub-topics (concepts) relating to the basal insulin (the aspect of diabetes associated with the basement). Particularly, the basement 700 includes, a picture frame 704 that is associated with the concept of “Basal Insulin Needs” (as indicated by the description 72), storage boxes 706 that are associated with the concept of “Pumps Deliver Basal Insulin”, and laundry machine 702 that is associated with the concept of “Temporary Basal Rates”. The association of the learning concepts with, for example, everyday items (in this case, house items) may facilitate the learning process and enable the user to more easily absorb and retain the presented information. For example, adjusting temporary basal rates in an insulin pump and adjusting a laundry machine, both share the principle of setting operation for a definite time duration per condition, e.g., a rate of 2 U/hr, during 40 minutes for an illness condition (in an insulin pump) versus a temperature of 40° C., during 40 minutes, for white clothing (in a laundry machine). Such analogies, may generate associations, in the mind of the user, between insulin pump operation and daily activities, and thus can ease memorizing process and facilitate his/her education on insulin pumps, for example. Generating such an association with the user may be achieved by a presenting a message (e.g., via the user interface), such as for example “Just as you can set washer or dryer cycles for specific types of clothing, you can program temporary basal rates into your insulin pump for specific activities like exercise, illness and travel. You can even set unique basal programs for different days of the week, times of the months, or seasons of the year”.

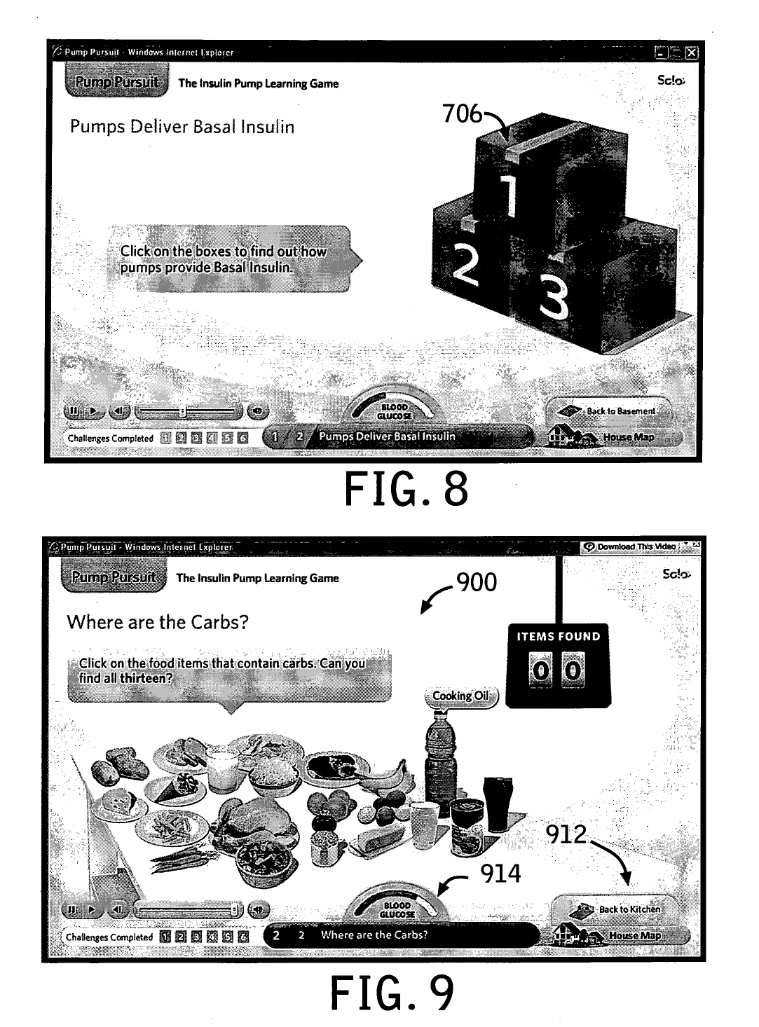

Selection of any of the items appearing in FIG. 7, or general parts of the interface (in this specific example, areas within the enlarged graphical rendering of the basement), causes the presentation of multimedia data related to the particular concept associated with those items (or parts of the interface). For example, selection of the storage boxes 706 appearing in FIG. 7 causes the presentation of multimedia content that includes the graphical content shown in FIG. 8. As illustrated in FIG. 8, that multimedia content includes an enlarged graphics of the storage boxes 706 appearing in FIG. 7, and a text-based prompt stating “Click on the boxes to find out how pumps provide Basal Insulin”. The multimedia content resulting from selection of the storage boxes 706 item of FIG. 7 enables the user to make more specific selection of sub-concepts from the concept selected through the multimedia presentation in FIG. 7. Thus, the multimedia data presented through a system such as system 100 may be organized in a hierarchical manner that enables the user to select progressively more specific sub-concepts of the general subject matter the user wishes to learn about.

As further shown in FIG. 7, the user may forego the learning exercises, and proceed to knowledge application/implementation learning activity (e.g., final challenge) relating to the information presented in the basement by selecting (e.g., clicking) on the area 710 marked as “Already know your stuff? Click to skip to the Stamp Challenge.”.

Turning back to FIG. 3, the presentation of multimedia data in any of the virtual environment's areas may be performed by presenting 330 at least one of: learning activities, challenges and awards for successful learning of the presented materials and tackling of the challenges. In some embodiments, navigating to an area of the virtual environment and/or selecting of portions within the selected area (e.g., selecting the captioned everyday items in the basement depicted in FIG. 7) will cause the commencement of a multimedia presentation which, as described herein, may include the delivery of pertinent information through at least one of: a monolog/dialog presentation by at least one narrator, video clips relating to the particular subject matter, presentation of text-based content and still images, presentation of audio-only content, etc.

Additionally, the multimedia content presented in the selected area of the virtual environment may include learning activities including one or more challenges that are related, at least in part, to the information delivered in that area of the virtual environment. For example, challenges presented in the basement area of the virtual environment include challenges dealing with topics/concepts of basal insulin. Challenges presented in the kitchen area 610b of the map 600 (as shown in FIG. 6), for example, may include challenges dealings with topics/concepts of carbohydrates (also referred-to as “carbs”). For example, and with reference to FIG. 9, a screenshot depicting multimedia content corresponding to a carbohydrate challenge 900 is shown. The challenge 900 presents to the user various food items and asks the user to select the food items (e.g., by clicking on the food item, using a mouse or some other pointing device) that contain carbohydrate. To tackle this particular challenge, the user may rely on his/her personal knowledge and according to his/her level of knowledge (which may be apparent by correct/incorrect answers) further information may be displayed, such as a description of the food, by moving or pointing a cursor on a food item. In other embodiments, the user would have had to view the presentation(s) relating to carbohydrates (such a presentation(s) would have been invoked upon navigation to the kitchen area and/or subsequent selection of various items areas within the rendered kitchen presentation), and based on the knowledge learned from the presentation(s), the user attempts to solve the challenge.

In some embodiments, if the user wishes to quit the challenge before ending, the user may be able to return to the rendered area within the virtual environment by selecting a region of the interface (e.g., clicking region 912 in FIG. 9 will enlarge the kitchen area, i.e., kitchen screen, as illustrated, for example, in FIG. 21). In some embodiments, the user may be able to navigate to any of the various challenges associated with the selected area of the virtual environment rather than systematically tackle the challenges in sequence. The progression status of a learning activity may be indicated via, for example, a blood glucose scale 914.

As described herein, in some embodiments, the presentation of challenges is further configured to provide the user with explanations of why a particular answer, or choice, is wrong when the user provides an improper response to the challenge. Thus, for example, in FIG. 9, the selection of a food item that does not contain carbs may result in the presentation of an explanation of why the user's selection of that item does not contain carbs. In some embodiments, the user's progress may be facilitated by presenting a hint (e.g., presenting a message containing a hint) related to the challenge, to assist the user in attaining the proper answer. Additionally, in some embodiments, a proper response, e.g., selection of a food item containing carbs in the challenge depicted in FIG. 9, results in the presentation of reinforcement information. In some embodiments, additional information relating the proper response may be displayed to further facilitate the learning process. Such additional information may include, for example, the amount of carbs of a food item, the ingredients of a food item, and any other elaborative information related to the food items, carbs and diabetes.

As further shown in FIG. 3, as multimedia data for a particular aspect of the subject matter (e.g., in relation to a selected area of the virtual environment) is presented (322 and/or 300), a determination may periodically be made 340 as to whether the learning activities associated with the currently selected aspect of the subject matter has concluded. For example, after a multimedia presentation for a particular concept/topic within the currently selected area of the virtual environment has finished, a determination can be made whether there are additional learning activities, be it additional multimedia presentations to deliver pertinent information, additional challenges, or otherwise, that the user has not yet gone over. If there are additional learning activities (as determined in 340), the multimedia presentation for the currently selected area can continue, and the user may select another concept/topic, challenge, or some other activity that still needs to be undertaken. The determination operations of 340 may be based, at least partly, on tracked level of the user's responsiveness. For example, in situations in which the number of completed challenges in the currently selected area of the virtual environment is being monitored, the determination of whether there are additional learning activities that remain to be completed may include a determination of whether the number of completed challenges matches the number of challenges known to be available with respect to the currently selected area of the virtual environment. As noted, in some embodiments, the user may skip some or all of the learning activities in a particular area of the virtual environment (for example, if the user previously completed those learning activities), and thus, under those circumstances, a determination of whether the user completed the learning activities (e.g., in the currently selected area of the virtual environment) may include determining, using, for example, a level of responsiveness data record, whether the user chose to skip some or all of the learning activities in the currently selected area of the virtual environment.

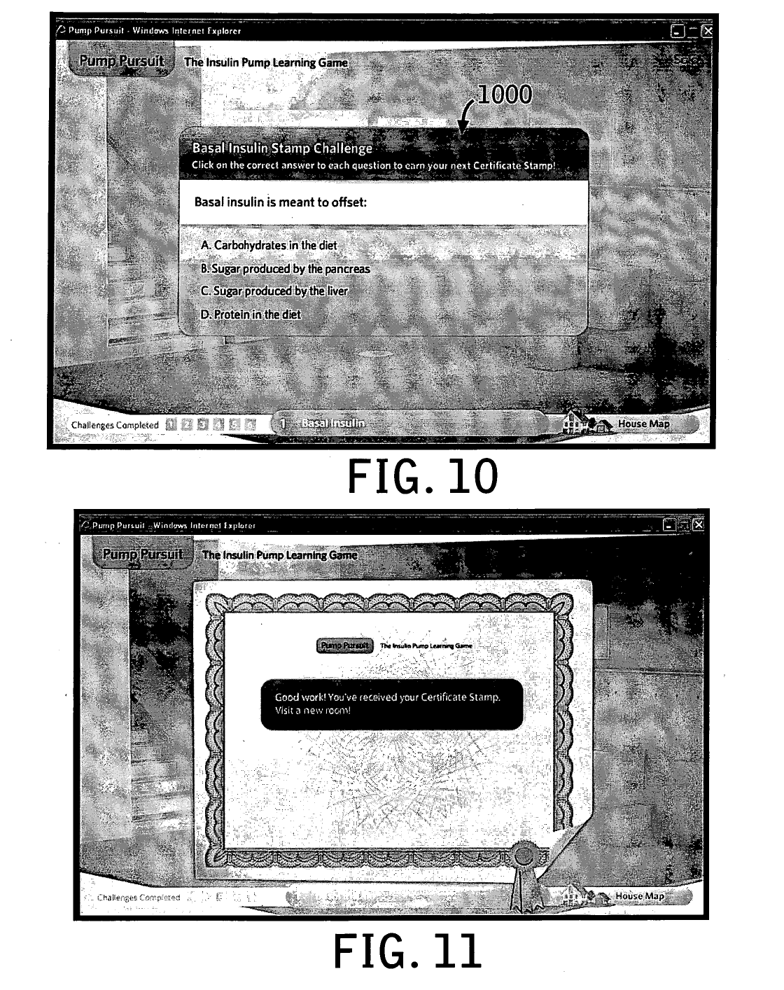

In response to a determination that there are no additional learning activities (e.g., if the user completed the required or available learning activities, if there is an indication that the user wishes to skip any, some or all of the activities, etc.), knowledge application/implementation operations are performed 350. The knowledge application/implementation operations enable the user, via a further presentation of multimedia data relating to the currently selected area of the virtual environment, to apply the knowledge the user acquired, to determine if the user mastered the information delivered in relation to the currently selected area of the virtual environment. For example, in some embodiments, the knowledge application operations may include a further (e.g., final) challenge(s) to test the user's knowledge (or skills) of the aspect of the subject matter covered in the currently selected area of the virtual environment. For example, FIG. 10 illustrates a multiple choice question 1000 which may be part of the final challenge in the basement area 610g of the virtual environment. Unlike some of the preceding learning activities in the currently selected area of the virtual environment, in some embodiments, the user may be required to undertake the knowledge application/implementation activity in order to complete the currently selected area of the virtual environment. Thus, under those circumstances, the user may not be given the option of skipping this learning activity. In some embodiments the application/implementation activity continues until a pre-determined level of responsiveness is achieved (e.g., 80% of correct/proper answers). In some embodiments, if the pre-determined level of responsiveness has not been achieved upon completion of the application/implementation activity, the system 100 may redirect the user to the currently selected area or to some other previously visited area of the virtual environment.

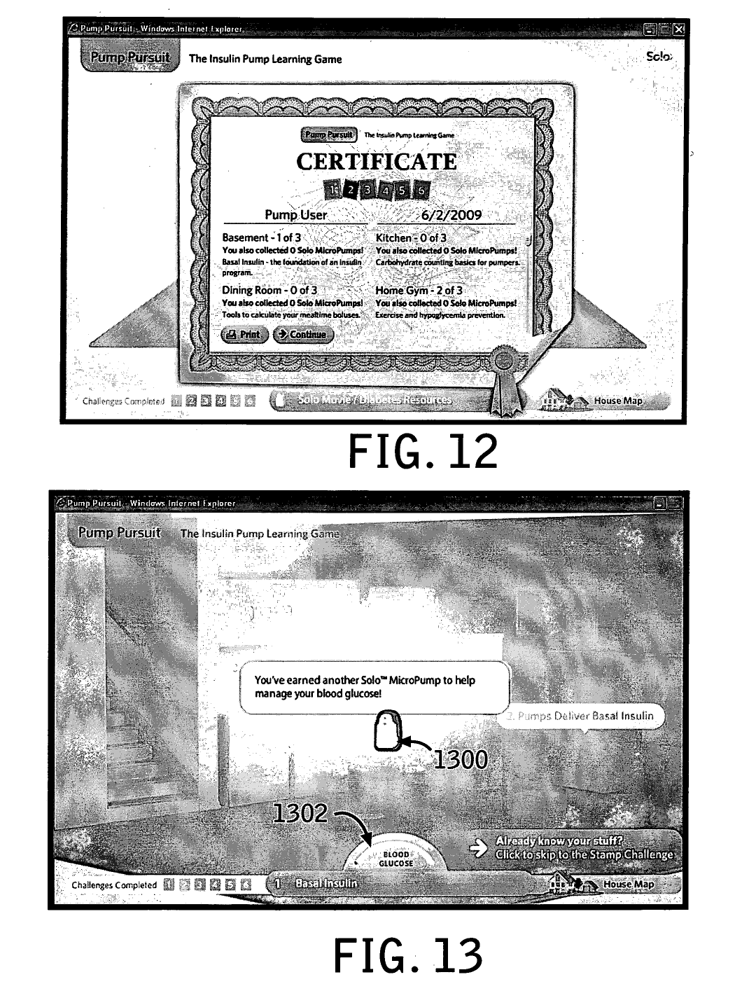

Returning to FIG. 3, when it is determined 360 that the user has completed the knowledge application/implementation activity (performed at 350), the user is awarded 370 with an award, such as a certificate (an example of a certificate is illustrated in FIG. 11). That the user completed the knowledge application/implementation activity may also be recorded, for example, in the data records tracking the user's level of responsiveness. The recorded level of responsiveness may be used in the presentation of the game award/a presentation-end award (e.g., a certificate as illustrated for example in FIG. 12), presented to the user after he/she has completed all challenges (for example). As described herein, other areas of the virtual environment (e.g., other rooms of the virtual house) may be visited upon completing the application/implementation activity. In some embodiments, other areas of the virtual environment may be visited only if it is determined, based on the user's recorded level of responsiveness, that the user has completed knowledge application/implementation activities relating to certain areas of the virtual environment.

As the user navigates through the virtual environment's various areas, the user gradually undertakes knowledge application/implementation activities for those visited areas. When it is determined 380 that the user has completed a pre-determined number of such knowledge application/implementation activities (in some embodiments, the pre-determined number of such knowledge application/implementation activities may be all the knowledge application/implementation activities associated with the virtual environment presented through the system 100), a game award (e.g., a certificate) is presented 390 to the user and may be recorded as part of the level of responsiveness record. If it is determined 380 that the user has not yet completed the pre-determined number of knowledge application/implementation activities, the user may be directed back to the navigation map to continue with the procedure 300, visit additional areas of the virtual environment, and have the operations 330-370 performed for additional areas of the virtual environment. In some embodiments, other criteria (e.g., time of responsiveness, improvement level compared to previous incidents, etc.) can be used in determining 380 whether the game/exercise should end.

FIG. 12 is a screenshot of an illustration of an example game certificate/award indicating that the user has visited a pre-determined number (e.g., all) of the areas of the virtual environment and completed the areas' respective knowledge application/implementation activities. Presenting such as a certificate may result from operation 390 shown in FIG. 3. In some embodiments, the award (certificate) may also include a score providing more details regarding the user's level of responsiveness. For example, the certificate may provide information on how many of the challenges associated with various areas of the virtual environment have been completed, what scores the user received in relation to completed challenges in particular areas of the virtual environments, what scores the user received in knowledge application/implementation activities, etc. For example, in some embodiments completion of one or more learning activities will be indicated by data representative of graphical certificate in the form of a “micropump” image, completion of one or more aspects of the medical information will be indicated by data representative of graphical certificate in the form of a “stamp image,” and completion of the presentation will be indicated by a data representative of graphical certificate in the form of a certificate image including the stamp images and/or number of earned “micropumps.”

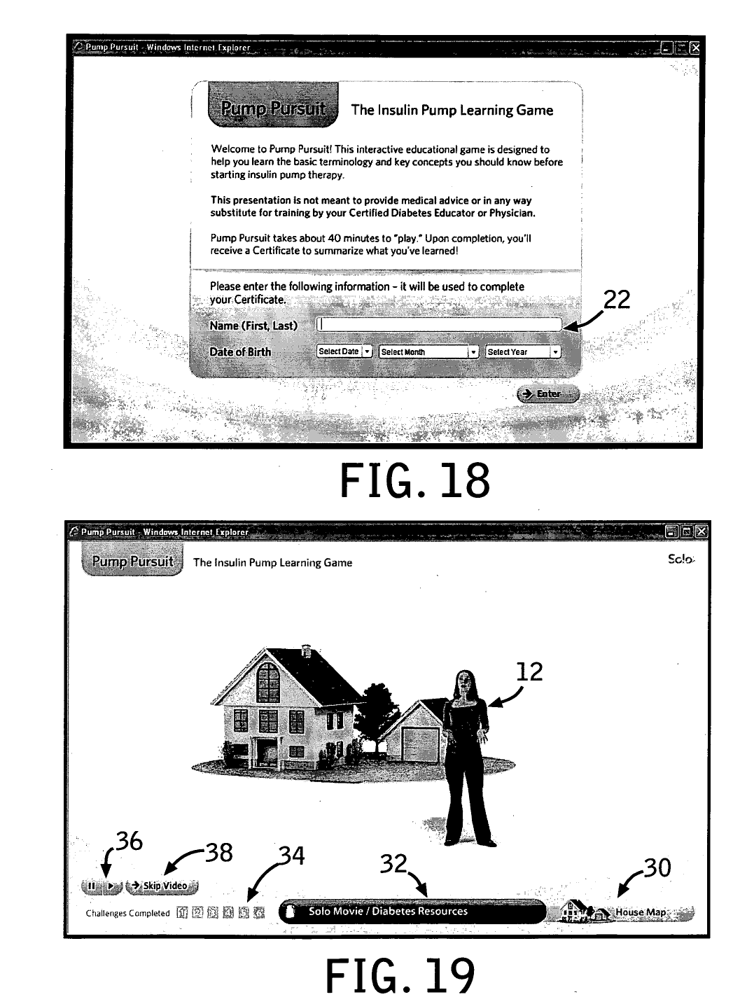

In some embodiments, FIG. 12 illustrates an example ending screen. The award may also include statistical analysis of the user's score (e.g., trend of improvement based on previous games), comparison with scores of other users, identification of the user's strengths and weaknesses, etc. The award may further include personal data of the user, such as birth date, age, name, etc. Other health condition data, such as for example Target Blood Glucose (TBG), Carbohydrate-to-Insulin Ratio (CIR), Insulin Sensitivity (IS), average blood pressure, current condition (e.g., illness, stress), and the like, may be also presented in the award. This data can be inputted (by the user, for example) and recorded using user interface of the presentation system, a screenshot of which is illustrated for example in reference to FIG. 18.

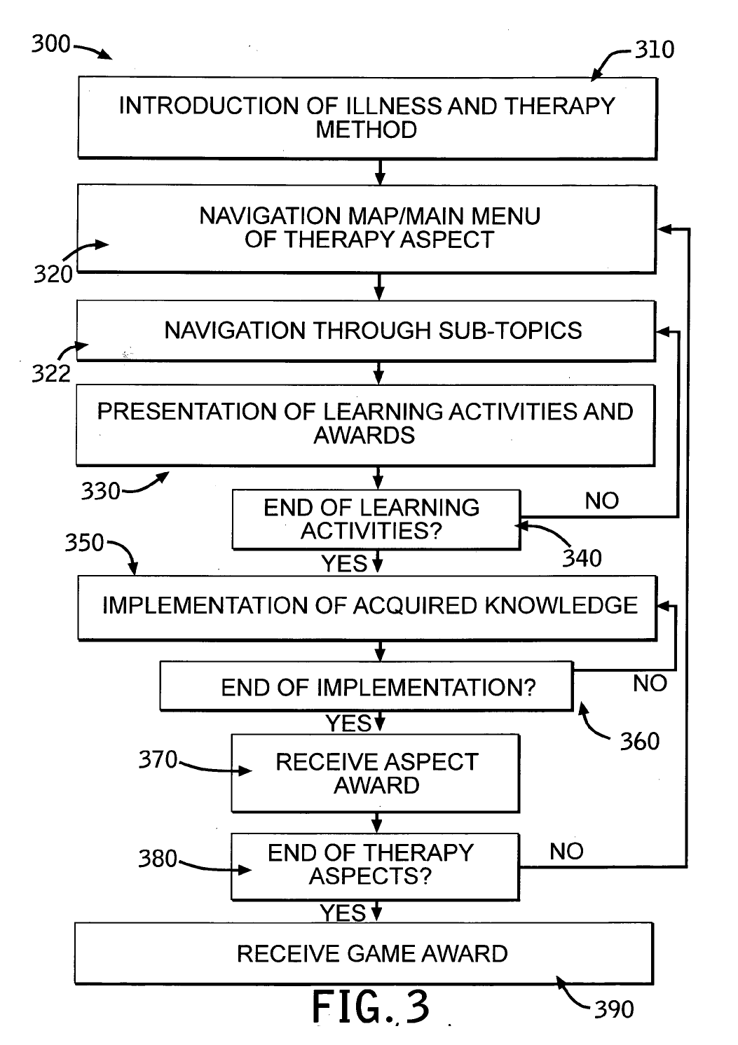

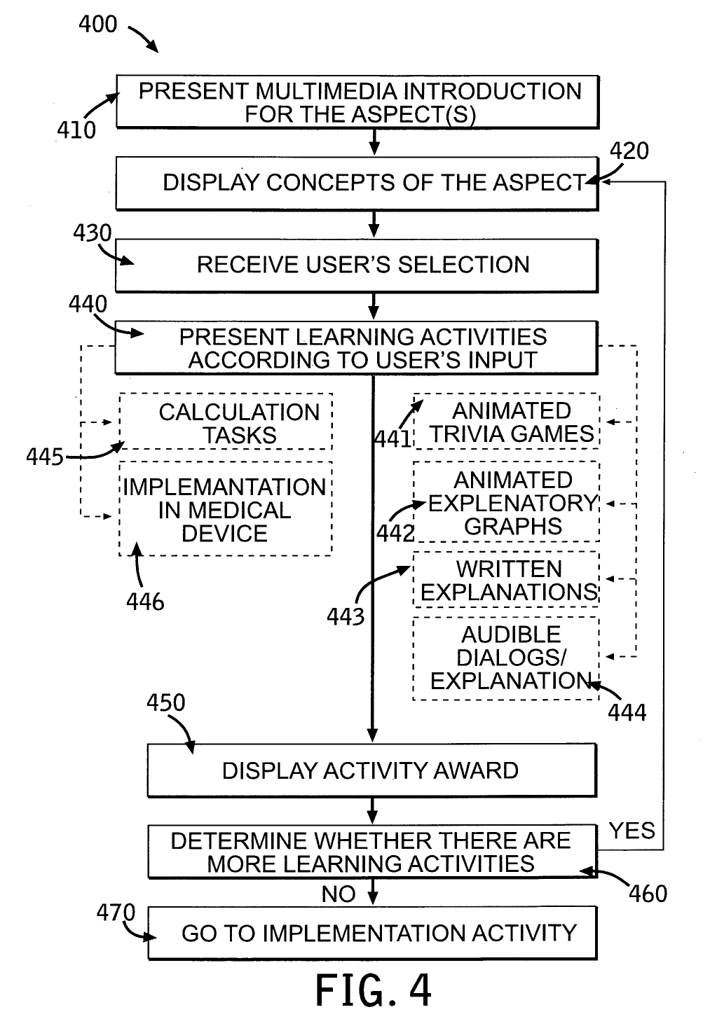

FIG. 4 is a flow diagram for a presentation procedure 400 providing further details in relation to the presentation of multimedia data within a particular area of the virtual environment. As described herein, in some embodiments, a particular area of a virtual environment (e.g., a room within a virtual house) is dedicated to presentation of a particular aspect(s) for the subject matter of the multimedia data being presented via a presentation system (such as the presentation system 100 of FIG. 1). When a user selects a particular area of the virtual environment, a multimedia introduction for the aspect(s) associated with the selected area is presented 410. Such a presentation may include a video clip by at least one narrator providing general information germane to the aspect dealt with in the selected area (or module). As with procedure 300, in some embodiments, the user may select to skip the introduction presentation by, for example, clicking on an icon (or some other portion of the screen) appearing on the screen (or other type of user interface).

Once the introduction presentation is completed (or skipped), a rendering of the selected area of the virtual environment (i.e., concepts of the aspect(s)) is presented 420, which includes selectable items or portions that, when selected, cause the presentation of topics/concepts respectively associated with the selectable items/portions. For example, as noted in relation to FIG. 7, a graphical rendering of the basement 610g of the house-based virtual environment includes selectable items to enable selection of basal insulin topics such as temporary basal rates, pumps to deliver basal insulin, etc., and thus enhance the learning thereof.

Additional examples for presentation of topics/concepts associated with the selectable items or portions within a selectable area of the house-based virtual environment relating to diabetes treatment are depicted in FIGS. 21-25.

FIG. 21 illustrates an example of a graphical rendering of the kitchen (designated by numeral 610b in FIG. 6) within the house-based virtual environment. The kitchen may include selectable items to enable learning of counting carbohydrates topics such as effect of carbohydrates on blood sugar (i.e., blood glucose), methods and rules for counting carbs, identifying food items which include carbs, etc.

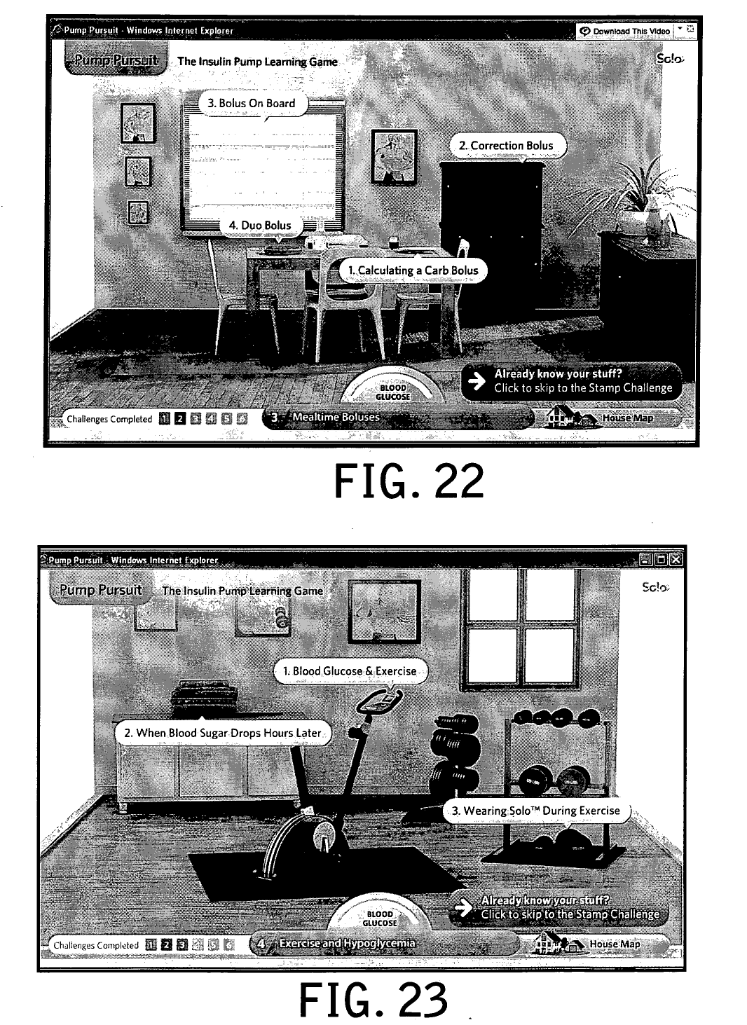

FIG. 22 illustrates an example of a graphical rendering of a dining room (designated by numeral 610e in FIG. 6) in the house-based virtual environment. The dining may include selectable items to enable learning of bolus related topics such as calculating a carbs bolus, understanding and calculating a correction bolus, a bolus with a plurality of delivery rates (e.g., duo bolus or dual bolus), bolus on board (or residual insulin), etc.

FIG. 23 illustrates an example of a graphical rendering of a gym (designated by numeral 610c in FIG. 6) in the house-based virtual environment. The gym may include selectable items to enable learning of topics relating to blood sugar management during physical activity and to hypoglycemia, such as for example insulin delivery before and after physical activity using an insulin pump.

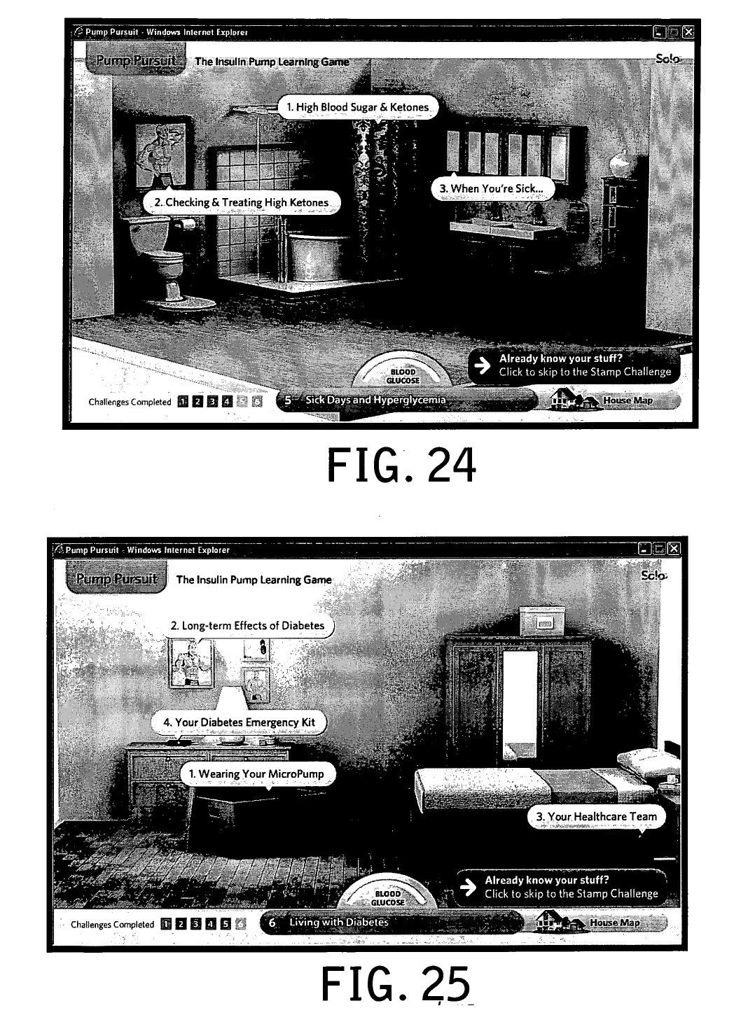

FIG. 24 illustrates an example of a graphical rendering of a bathroom (designated by numeral 610a in FIG. 6) in the house-based virtual environment. The bathroom may include selectable items to enable learning of topics relating to blood sugar management during sick days (illness) and hyperglycemia such as checking and treating high blood sugar and ketones (e.g., ketoacidosis).

FIG. 25 illustrates an example of a graphical rendering of a bedroom (designated by numeral 610d in FIG. 6) in the house-based virtual environment. The bedroom may include selectable items to enable learning of common topics relating to life with diabetes, such as long term effect of diabetes management, keeping an emergency kit, usage of insulin pump, etc. In some embodiments the bedroom may include a learning topic relating to managing insulin delivery and/or blood sugar monitoring while sleeping (e.g., managing the “dawn effect”).

Returning to FIG. 4, when a selectable area of the virtual environment is rendered, the user can then select, for example, by clicking on one of the selectable items in the rendered presentation of the selected area of the virtual environment, a topic/concept for which the user wishes to obtain more information and partake in learning activities.

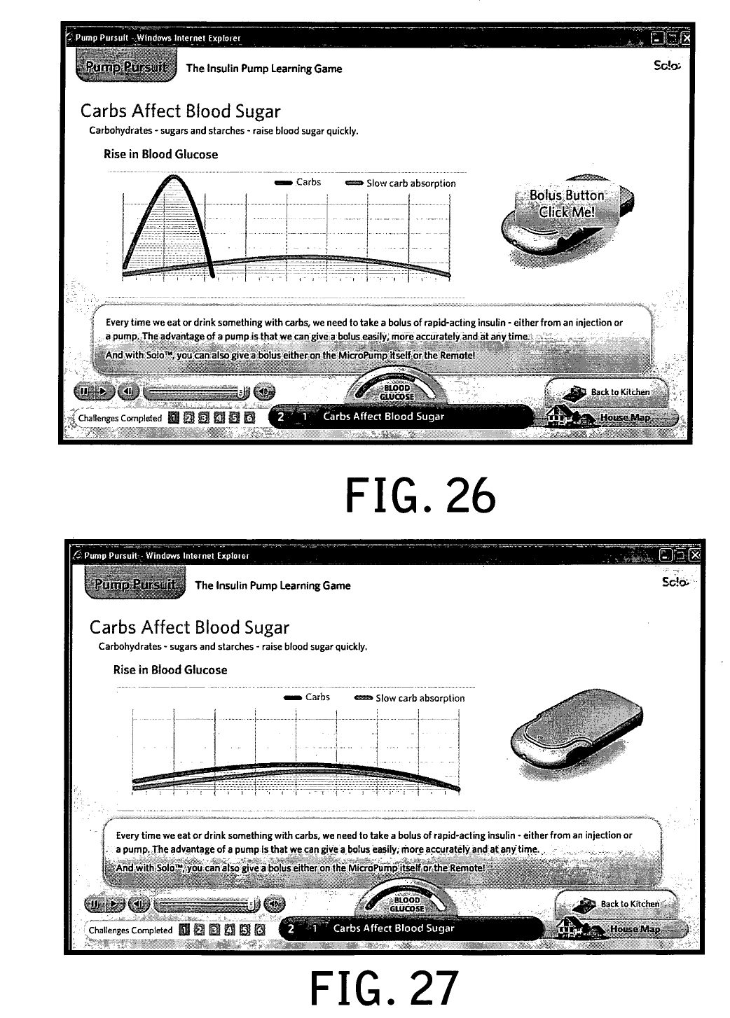

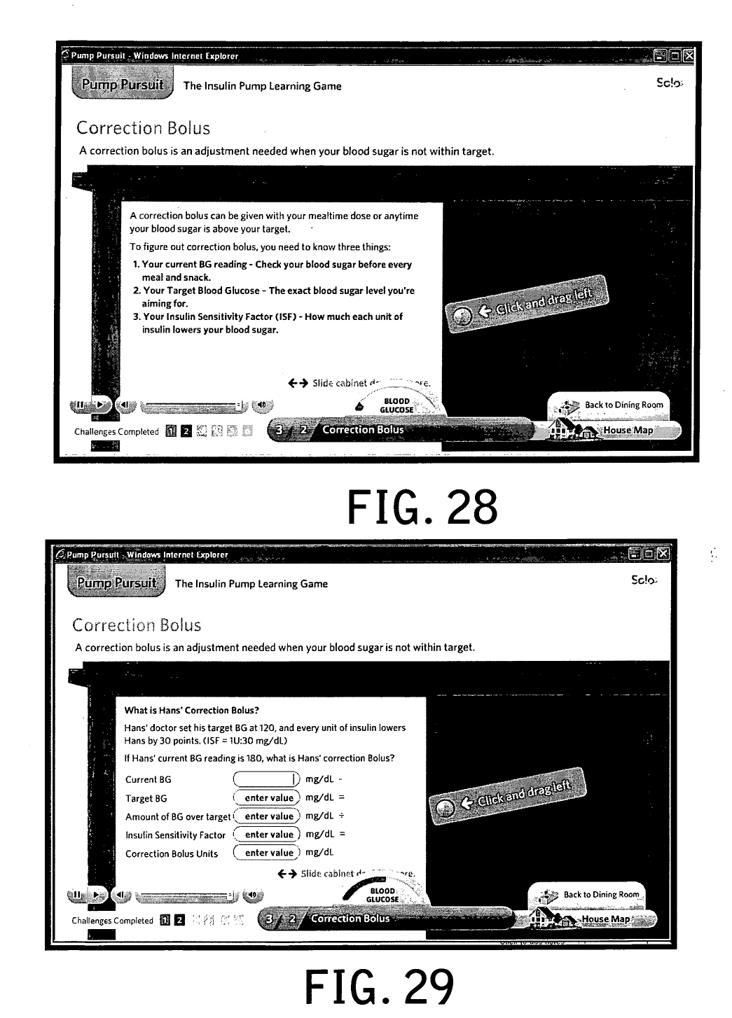

Thus, upon receiving 430 the user's selection, multimedia data, including one or more learning activities (such as presentation of information, challenges, etc,) is presented 440. Examples of learning activities associated with topics/concepts covered within the selected area of the virtual environment can include:
Presentation of animated trivia games (or question-based games) 441, for example identifying food items that contain carbs as shown in FIG. 9, and described herein;
Presentation of animated explanatory graphs 442, shown for example in FIGS. 26-27 describing the blood glucose behavior in response to carbs consuming without insulin treatment in comparison with that following insulin administration;
Presentation of written explanations 443, as shown for example, in FIG. 28, presenting an explanation on parameters based on which a correction bolus can be calculated;
Presentation of audible monologs/dialogs/explanations 444, as depicted hereinafter, for instance, in Example No. 5 of Appendix A;
Presentation of calculation tasks 445, as shown in FIG. 29 (for example), presenting a calculation task, e.g., calculation of a correction bolus.; and
Presentation regarding implementing therapy using a medical device such as insulin pump 446 shown, for example, in FIGS. 26-27, describing bolus dose administration using buttons (switches) located on an insulin pump.

As described herein, presentation resulting from the user's responsiveness to any of the learning activities, including any challenges, does not affect multimedia data corresponding to the scripted presentation of any of the narrators used to deliver the information to the user. Thus, the controlled presentation resulting from the user's response input is independent and non-interactive with the scripted presentation of the at least one narrator.

Upon completion of a learning activity within the selected area of the virtual environment, the user may receive an award, which is presented 450 on the system (e.g., via the user interface or output interface), and data representative of the user's completion of the activity (and optionally a score received in the event that the completed learning activity was a challenge) is recorded (for example, in a data record tracking the user's responsiveness level which can be stored in a mass storage device or memory of the system). FIG. 13 is a screenshot of an example award indicating the user's completion of a learning activity. As shown in this example, a user can earn a “micropump” 1300 upon completion of one or more learning activities. In some embodiments, the number of completed learning activities may be indicated through, for example, a blood glucose scale 1302.

As further shown in FIG. 4, upon a determination 460 that there are no more learning activities, or that the user decided to skip the learning activities in the currently selected area of the virtual environment, the user is presented 470 with a knowledge application/implementation learning activity, which may be similar to the knowledge application/implementation presentation in operation 350 of FIG. 3. When the user completes the knowledge application/implementation learning activity (e.g., a final challenge for the currently selected area), the user may receive a feedback (e.g., encouraging or reinforcing indication) for completing the knowledge application/implementation learning activity of the selected area of the virtual environment. An example for such a feedback is a stamp (which can be also presented in the final game certificate). As noted, in some embodiments, the number and nature of received reinforcement indications (e.g., stamp) can be used to determine and control which areas of the virtual environment the user may subsequently visit or be allowed to visit. If it is determined, at 460, that there are additional learning activities associated with the currently selected area of the virtual environment that have not been completed yet, and the user has not chosen to skip any of those learning activities, further learning activities may be presented in accordance with operations 430 to 450.

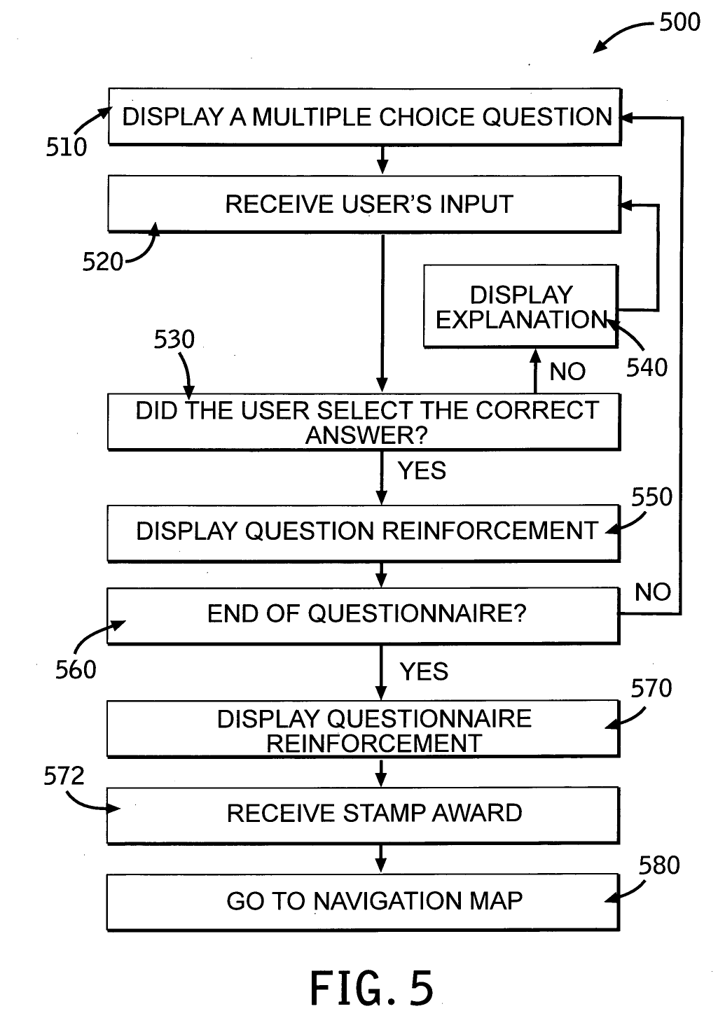

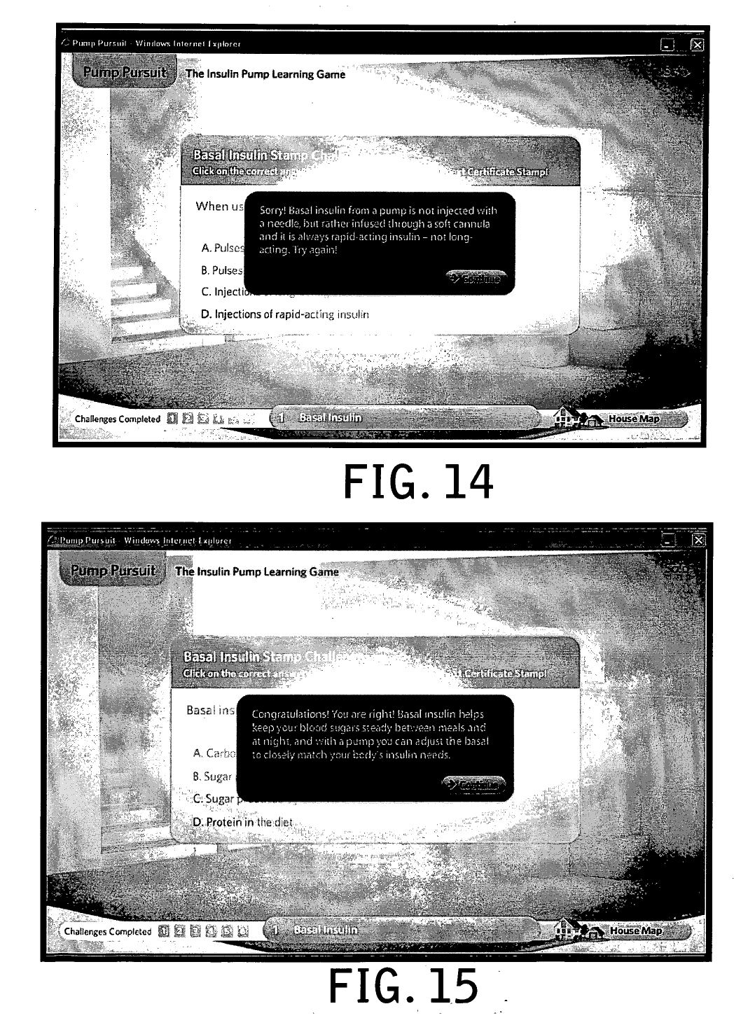

FIG. 5 is a flow diagram for a presentation procedure 500 providing an example to a knowledge application/implementation activity (correspond, for example, to operation 350 in FIG. 3) within a particular area of the virtual environment. As noted above, to complete an area (module) of the virtual environment, and receive credit therefor (which may be used to determine and control which other areas the user may be allowed to navigate to), the user is presented with a knowledge application/implementation challenge. In the example of FIG. 5, the knowledge application/implementation learning activity (e.g., the final challenge) is displayed to the user as a questionnaire including of one or more multiple choice questions 510. The user's response to the at least one of the questions (such questions may also be referred-to as “challenge”) is then received 520, and a determination is made 530 as to whether the user provided a proper answer. A proper response could be a correct answer to a multiple-choice question (as in the current example), an item selected from a number of presented items that matches a certain criterion (see FIG. 9, for example), etc. Upon a determination that user failed to provide a proper response (e.g., the user provides a wrong answer to a multiple-choice question), an explanation of why the user's response is improper is presented 540. An example of such an explanation of why a user's response is improper is shown in FIG. 14. If it is determined that the user response is proper (e.g., the user correctly answered a multiple-choice question), reinforcement information (i.e., reinforcement feedback) is presented 550. An example of such a reinforcement information is shown in FIG. 15. Thus, the presentation of multimedia data may be controlled, at least in part, based on the user's determined level of responsiveness to a challenge (e.g., a multiple-choice question). However, here too, such controlled presentation of multimedia data does not affect the scripted presentation of the multimedia data corresponding to a narrator.

In some embodiments, the questions and their characteristics (e.g., difficulty, language) can be selected dynamically and may be matched to a specific user, his/her age, level of understanding, correct/incorrect answers, history of questions for the specific user, etc. In some embodiments, the user may gain or lose points according to his/her correct/incorrect answers. These data can be stored in a memory, and may be retrieved for various purposes (e.g., to maintain the score in the game, to show improvement of the user, to allow competition between users, which can be carried out for example online between remote users, etc.)

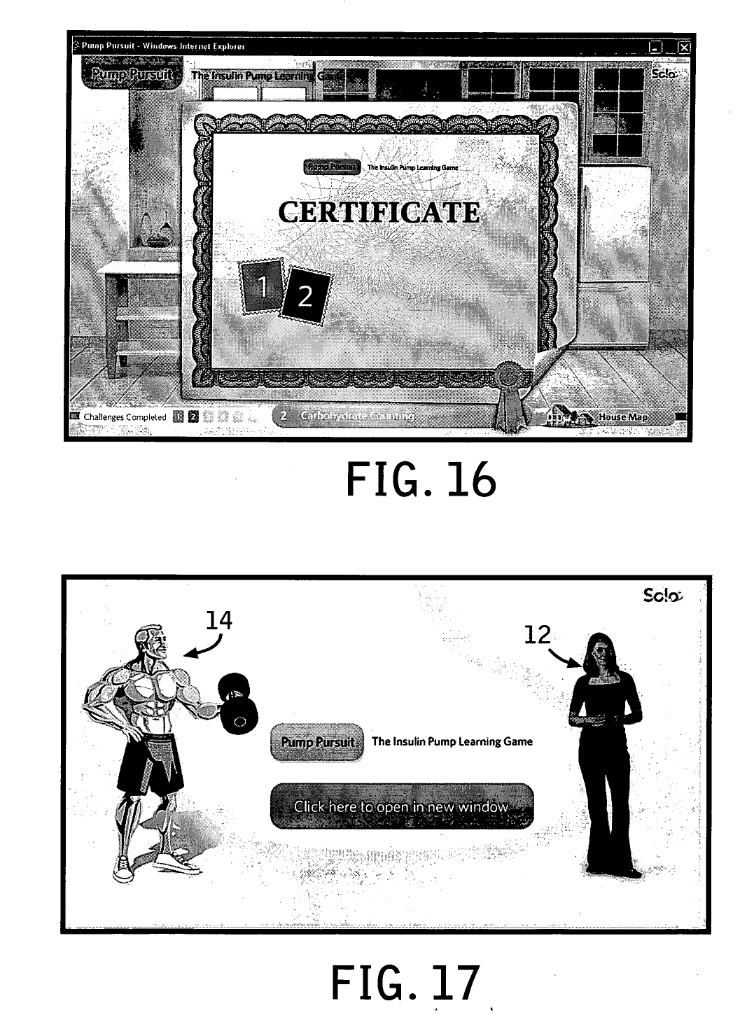

Upon a determination, at 560 that there are no additional questions or challenges associated with the stamp challenge (or questionnaire challenge) of the currently selected area of the virtual environment, a reinforcement information (feedback) may be presented 570 (see, for example, FIG. 11) and/or presentation of merit or award such as a congratulatory certificate (e.g., a “stamp”, see, for example, FIG. 16) may be presented to the user. If, however, it is determined that there are additional challenges associated with the current stamp challenge, the next challenge/question of the current stamp challenge is presented and processed according to operations 510 to 550.

After completing the stamp challenge, as well as receiving, for example, a certificate, and recording the completion of the stamp challenge (for example, in a user responsiveness data record), the user can be directed 580 to the navigation map of the virtual environment (a map such as, for example, the map depicted in FIG. 6) to enable the user to navigate to another area of the virtual environment.

In some embodiments, the user can select the language of the game, e.g., English, Spanish, Chinese or any other language. Upon selecting the language of the games, at least a portion (if not all) of the presentations and contents (including scripts, video clips, audio and visual presentations, etc.) is presented in the selected language. The system 100 may have the presentations and contents stored in memory(ies) or mass storage device(s), retrievable upon selection of the language. In some embodiments, the game can be adapted for disabled users, for example, providing special instructions for deaf users, or blind users, using appropriate devices (to provide audio instructions, “sign language” instructions, and/or Braille-based instructions). In some embodiments, the contents (e.g., synopsis, script, text, info, type of room) of the presentations/game are adapted to the user's parameters and/or characteristics. For example, the system may present different presentations (e.g., script, contents) for a child (e.g., 8 years old) compared to the script presented for an adult, different presentations can be presented for a boy compared to that presented to a girl, etc.

Various embodiments of the subject matter described herein may be realized in digital electronic circuitry, integrated circuitry, specially designed ASICs (application specific integrated circuits), computer hardware, firmware, software, and/or combinations thereof. These various embodiments may include embodiment in one or more computer programs that are executable and/or interpretable on a programmable system including at least one programmable processor, which may be special or general purpose, coupled to receive data and instructions from, and to transmit data and instructions to, a storage system, at least one input device, and at least one output device. In particular, some embodiments include specific “modules” which may be implemented as digital electronic circuitry, integrated circuitry, specially designed ASICs (application specific integrated circuits), computer hardware, firmware, software, and/or combinations thereof.

These computer programs (also known as programs, software, software applications or code) include machine instructions for a programmable processor, and may be implemented in a high-level procedural and/or object-oriented programming language, and/or in assembly/machine language. As used herein, the term “machine-readable medium” refers to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

Some or all of the subject matter described herein may be implemented in a computing system that includes a back-end component (e.g., as a data server), or that includes a middleware component (e.g., an application server), or that includes a front-end component (e.g., a client computer having a graphical user interface or a Web browser through which a user may interact with an embodiment of the subject matter described herein), or any combination of such back-end, middleware, or front-end components. The components of the system may be interconnected by any form or medium of digital data communication (e.g., a communication network). Examples of communication networks include a local area network (“LAN”), a wide area network (“WAN”), and the Internet.

The computing system may include clients and servers. A client and server are generally remote from each other and typically interact through a communication network. The relationship of client and server arises by virtue of computer programs running on the respective computers and having a client-server relationship to each other.

Some embodiments of the present disclosure preferably implement the PPH alleviation feature via software operated on a processor contained in a remote control device of an insulin dispensing system and/or a processor contained in an insulin dispensing device being part of an insulin dispensing system.

Any and all references to publications or other documents, including but not limited to, patents, patent applications, articles, webpages, books, etc., presented in the present application, are herein incorporated by reference in their entireties.

### OTHER EMBODIMENTS

A number of embodiments of the invention have been described. Nevertheless, it will be understood that various modifications may be made without departing from the spirit and scope of the invention. Accordingly, other embodiments are within the scope of the following claims.

### APPENDIX A

In the following examples of scripted dialog between a narrator, “Suzy”, and an animated character, “Hans” (which may be also referred-to as a narrator, in some embodiments), the two characters discuss the fluid infusion device “Solo™” which may be similar to the device disclosed, for example, in PCT application No. PCT/IL2009/000388, the content of which is hereby incorporated by reference in its entirety.

### Example 1

### A Video Script of Game Intro/Introduction (Shown Video and Audio)

| VIDEO | AUDIO |
|---|---|
| SUZY walks into the | SUZY |
| VOID. | |
| | Diabetes is not easy, but it doesn't have to |
| | stop you from living the life you want. |
| A HOUSE “FLIPS” | |
| up from the ground | |
| behind SUZY. | (PAUSE) |
| | I'm Suzy, your guide to Pump Pursuit - The |
| | Insulin Pump Learning Game. |
| | (PAUSE) |
| Now a LIVING | |
| ROOM set FLIPS up, | |
| replacing the house. | We're going to help a friend of mine |
| | discover the benefits of insulin pump |
| | therapy. Along the way we'll learn some new |
| The LIVING ROOM | things . . . And have some fun! Now let's |
| ZOOMS FORWARD, | meet . . . |
| until SUZY is totally | |
| inside the room. | |

### Example 2

### A Video Script of a Game Setup (Living Room)

| VIDEO | AUDIO |
|---|---|
| SUZY introduces HANS, | SUZY (CONT'D) |
| who's curling dumbbells. | |
| | . . . Hans. |
| | HANS |
| | The only thing I pump is iron. |
| | SUZY |
| | How's your diabetes management going, |
| | Hans? |
| | HANS |
| | I've been taking shots since I could barely |
| | pick up a Volkswagen. And you, Suzy? |
| | SUZY |
| | Well, I've never lifted a Volkswagen, but |
| | I've had diabetes for a while too. To better |
| | manage it, I use an insulin pump. |
| | HANS |
| | Doesn't that get in the way when you work |
| | out? |
| | SUZY |
| HANS is skeptical. | Nope! The Solo MicroPump is tiny and has |
| | no tubing, so it never gets in the way! |
| | HANS |
| | Wow, I didn't even notice it . . . Why do |
| SUZY pulls up shirt to | people make such a big deal out of these |
| reveal Solo MicroPump. | pumps? |
| | SUZY |
| | Tell you what, Hans: let's play a game so |
| | you can see what all the fuss is about . . . |
| HANS is now curious. | |
| HANS raises an eyebrow. | |

### Example 3

### A Video Script for a Game Setup

| VIDEO | AUDIO |
|---|---|
| SUZY and HANS in | HANS |
| LIVING ROOM. | |
| | Well, I'm ready to see what these pumps are |
| | all about! |
| The 3D HOUSE/NAV | |
| MAP is now onscreen. | |
| | SUZY |
| Indicates 3D NAV MAP. | How about you? Click on the house map to |
| Indicates “FAST | start the game. Or you can first watch a short |
| TRACK” BUTTON. | movie on the features of the Solo |
| | MicroPump. Ready when you are! |
| A CLIP (no sound) begins | |
| playing on the HDTV | |
| screen. | |

### Example 4

### A Video Script for Intro for Room No. 1

| VIDEO | AUDIO |
|---|---|
| HANS glancing around. | HANS |
| | Eh, Suzy? Why are we going into the |
| | basement? |
| | SUZY |
| | Because every successful project starts with a |
| | solid foundation. |
| | HANS |
| | Something's wrong with the house's |
| | foundation?! |
| HANS PANICS. | |
| | SUZY |
| | Easy, Hans—this house's foundation is fine. |
| | But like any well built home, an insulin |
| | program needs a solid foundation, too. And |
| | that foundation comes in the form of BASAL |
| | INSULIN. |
| | HANS |
| | I still don't get it . . . |
| FADE UP TEXT: | |
| “BASAL INSULIN” | |
| | SUZY |
| | Then let's take a closer look! |
| HANS LOOKS | |
| CONFUSED | |
| SUZY ADDRESSES | |
| US FULLY: | |

### Example 5

### A Video Script for the Basal Insulin Needs Window/Screen

| ANIMATION | VOICEOVER |
|---|---|
| HANS PHOTO on the shelf | SUZY (VO) |
| ANIMATES - WE ZOOM | |
| INTO HIS BODY and it | |
| suddenly becomes an | In addition to “mealtime” insulin, our bodies |
| anatomy chart. | also need “basal” insulin to offset the sugar |
| | produced by our livers. |
| INDICATE the LIVER. | |
| | HANS (VO) |
| | I like liver. It gives me iron for building |
| | muscles. |
| | SUZY (VO) |
| SUZY rolls her eyes. | |
| | Not that kind of liver, Hans. |
| | (PAUSE) |
| SUGAR CUBES trickle | The liver releases sugar, or glucose, into the |
| from the liver and are | bloodstream all day and all night so that our |
| absorbed by various | brain, organs, and muscles have energy to |
| organs such as the heart | burn. |
| and brain and muscles. | |
| | (PAUSE) |
| | However, everyone's body produces |
| “Typical Basal Needs” | hormones at different times of day, some of |
| CHART [Room 1 | which can cause the liver to produce extra |
| Appendix, IMAGE 1-A] - | sugar. That's why the amount of insulin you |
| the “Avg. Basal Needs” | need can change throughout the day. |
| line winds along the | |
| graph. | |

### Example 6

### A Video Script for Basal and Bolus Delivery Window/Screen

| VIDEO | AUDIO |
|---|---|
| SUZY and HANS. | HANS |
| | So, basal insulin is the foundation of my |
| | insulin program. But I like to eat. I still need |
| | insulin for food, right? |
| ANIMATE CHART: | |
| “Basal and Bolus | |
| Delivery” - RED | |
| ARCS popup for each | |
| spike labeled: “breakfast,” | SUZY |
| “lunch”, “dinner” | |
| | Absolutely! But when the basal insulin from |
| | a pump is matched up to the liver, managing |
| | the mealtime doses and adjusting for |
| | activities like exercise become so much |
| | easier. |

### Example 7

### A Video Script of an Intro for Room No. 2

| VIDEO | AUDIO |
|---|---|
| HANS holds a plate | HANS |
| of DUMPLINGS. | |
| SUZY an APPLE. | |
| | Ahh, the kitchen. Where Hans gets his |
| | energy. Dumplings? |
| | SUZY |
| SUZY offers the APPLE. | No thanks, Hans... Apple? |
| | HANS |
| | Doesn't fruit make your blood sugar go too |
| | high? |
| | SUZY |
| | Believe it or not, those dumplings could raise |
| | your blood sugar more than a piece of fruit. |
| | That's why COUNTING CARBS is so |
| | important. |
| SUZY & HANS are now | |
| in the KITCHEN: FADE | |
| UP TEXT: “COUNTING | |
| CARBS” | |
| | HANS |
| | Oh, those pesky carbs! It's tough to keep |
| | track of them. |
| | SUZY |
| | Well let's show you a few tricks to make it |
| | easier! |
| SUZY ADDRESSES US | |
| FULLY. | |

1. A multi-media medical presentation method for enhanced learning of medical information comprising:
presenting multimedia data on a multimedia presentation device to a user based, at least in part, on input received from the user, wherein the multimedia data includes scripted presentation of at least one narrator to present information to the user, and includes multimedia presentation of one or more learning activities, including one or more challenges, wherein at least one of the one or more challenges is based on medical information provided via the at least one narrator, and/or via the learning activities; and
controlling, based at least in part on responsiveness of the user's input, the presentation of the multimedia data to enhance learning by the user of the medical information, the controlled presentation resulting from the user's input being independent and non-interactive with the scripted presentation of the at least one narrator.

2. The method of claim 1, wherein the one or more learning activities comprise one or more of: presentation of animated trivia games, presentation of question-based games, presentation of animated explanatory graphs, presentation of written explanations, presentation of audible dialogs/explanations, presentation of calculation tasks, and presentation regarding implementing therapy using a medical device.

3. The method of claim 1, wherein the one or more learning activities comprise knowledge implementation learning activities, including one or more challenges based on information provided via the multimedia presentation.

4. The method of claim 3, wherein the knowledge implementation learning activities comprise one or more multiple choice questions.

5. The method of claim 1, wherein the one or more challenges comprise one or more of:
selecting a remedy from a plurality of possible remedies to treat a medical condition presented, the selected remedy causing presentation of multimedia data associated with the effect of the selected remedy to treat the condition;
selecting an answer from a plurality of possible answers to a presented question, the selected answer causing presentation of multimedia information responsive to the selected answer;
selecting one or more items from a plurality of items in response to presentation of data prompting selection of items meeting one or more criteria; and
determining an answer in response to a presentation of a calculation task.

6. (canceled)

7. The method of claim 6, wherein the virtual environment comprises one or more selectable areas, wherein the one or more selectable areas comprise presentation of the one or more learning activities, and wherein the one or more selectable areas correspond to one or more aspects of the medical information.

8. (canceled)

9. The method of claim 8, wherein the one or more aspects of the medical information associated with at least one of: delivery of insulin basal doses, delivery of insulin bolus doses, insulin delivery during physical activity, insulin delivery during illness, insulin delivery during sleeping, hyperglycemia, hypoglycemia, and life with diabetes.

10. The method of claim 6, wherein the virtual environment comprises: graphical representation of a house including one or more rooms, each of the one or more rooms being representative of corresponding aspects of the medical information, wherein selection of at least one of the one or more rooms causes an enlarged presentation of the selected at least one of the one or more rooms and presentation of the corresponding aspects of the medical information, the presentation of the corresponding aspects of the medical information including presentation of at least one of the one or more learning activities associated with the selected at least one of the one or more rooms.

11. The method of claim 10, wherein selection of at least one other of the one or more rooms is based on a level of responsiveness such that when the level of responsiveness is indicative that at least one of the one or more challenges required to be completed before multimedia data associated with at least one other of the one or more rooms can be presented have not been completed, the selection of the at least one other room causes presentation of information indicating that the at least one of the one or more challenges is required to be completed to unlock the at least one other of the one or more rooms.

12. The method of claim 1, wherein the controlling the presentation of the multimedia data is based, at least in part, on prior knowledge of the user.

13. The method of claim 1, further comprising determining level of responsiveness of the user's input to one or more of the challenges.

14. The method of claim 13, wherein determining the level of responsiveness includes determining whether the user provided proper response to the one or more challenges based on a predetermined criteria.

15. The method of claim 13, wherein determining the level of responsiveness includes one or more of the following: determining whether the user provided proper response to the one or more challenges, determining a number of successful responses to the one or more challenges, and determining whether the number of successful responses matches a pre-determined threshold.

16. The method of claim 13, wherein controlling the presentation of the multimedia data is based, at least in part, on the determined level of the responsiveness.

17. The method of claim 16, wherein controlling the presentation of the multimedia data includes one or more of:
presenting reasons why the user's response input to a particular one of the one or more challenges is not proper when the user fails to properly complete the particular one of the one or more challenges,
presenting to the user reinforcement information when the user successfully completes the particular one of the one or more challenge, and
enabling presentation of multimedia data according to a number of successful responses that matches a pre-determined threshold.

18. The method of claim 13, wherein the level of responsiveness includes data representative of completion of at least one of the one or more challenges, and data identifying the respective at least one of the one or more challenges.

19. (canceled)

20. The method of claim 13, further comprising recording, to a memory device, the level of responsiveness of the user's input to the one or more of the challenges.

21. The method of claim 20, further comprising presenting the recorded level of responsiveness in a presentation-ending multimedia data.

22. The method of claim 13, wherein controlling the presentation of the multimedia data comprises: presenting presentation-ending multimedia data in response to a determination that the level of responsiveness matches a value corresponding to successful responses to a pre-determined number of the one or more challenges.

23. The method of claim 22, wherein the pre-determined number includes all the one or more challenges.

24-62. (canceled)
